(19) United States
(12) Patent Application Publication
(10) Pub. No.: US 2011/0007976 A1
(43) Pub. Date: Jan. 13, 2011

(54) IMAGE DATA COMPRESSION APPARATUS AND IMAGE DATA COMPRESSION PROGRAM STORAGE MEDIUM

(75) Inventor: Yukio SUGITA, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM CORPORATION, Tokyo (JP)

(21) Appl. No.: 12/797,500

(22) Filed: Jun. 9, 2010

(30) Foreign Application Priority Data
Jul. 8, 2009 (JP) 2009-161951

(51) Int. Cl. G06K 9/36

(52) U.S. Cl. 382/232

(57) ABSTRACT

The image data compression apparatus includes a reversible compression section that applies reversible compression processing to to-be-compressed data made of a series of numeric values; an irreversible compression section that applies irreversible compression processing to to-be-compressed data made of a series of numeric values; and a compression control section that causes, if a difference between a maximum value and a minimum value in plural pixel values representing plural pixels forming an image is within a range from a predetermined upper limit to a predetermined lower limit, the irreversible compression section to execute the irreversible compression processing for the plural pixel values as the to-be-compressed data, and that causes, if the difference is out of the range, the reversible compression section to execute the reversible compression processing for the plural pixel values as the to-be-compressed data.

### TECHNICAL FIELD

The present invention is directed to an image data compression apparatus and a computer-readable storage medium storing an image data compression program to compress image data representing an image.

### BACKGROUND ART

There is known an image data compression apparatus that compresses image data for communications and storage. As a compression algorithm, for example, as represented by a JPEG (Joint Photographic Experts Group) method, there is known an irreversible compression algorithm that improves a compression ratio by quantizing on the understanding that data before compression is not completely restored. Also, there is known a data compression method in which one screen is divided into blocks, a width of quantization based on a maximum value of predicted errors obtained by using adjacent samples in each block is determined, and a differential PCM (Pulse Code Modulation) encoding is performed with the determined width of quantization (see, for example, Japanese Patent Laid-open Application No. H5-95487).

However, if an irreversible compression is performed in order to improve a compression ratio, original data may not be obtained by decompression processing even with an adjustment of the width of quantization. For example, an image including a character portion or a high contrast becomes unclear and the image quality is deteriorated. In this way, it is not easy to balance a compression ratio and image quality in compression processing.

The present invention addresses the above-described problems and provides an image data compression apparatus and a computer-readable storage medium storing an image data compression program that balances a compression ratio of data and image quality.

### DISCLOSURE OF INVENTION

According to a first aspect of the invention, an image data compression apparatus includes:

a reversible compression section that applies reversible compression processing to to-be-compressed data made of a series of numeric values;

an irreversible compression section that applies irreversible compression processing to to-be-compressed data made of a series of numeric values; and

a compression control section that causes, if a difference between a maximum value and a minimum value in plural pixel values representing plural pixels forming an image is within a range from a predetermined upper limit to a predetermined lower limit, the irreversible compression section to execute the irreversible compression processing for the plural pixel values as the to-be-compressed data, and that causes, if the difference is out of the range, the reversible compression section to execute the reversible compression processing for the plural pixel values as the to-be-compressed data.

In the image data compression apparatus according to the first aspect of the invention, if a difference between a maximum value and a minimum value in plural pixel values is within a predetermined range, the irreversible compression processing is executed, and if the difference is out of the predetermined range, the reversible compression processing is executed. An image including a character or a high-contrast portion generally has a large difference between a maximum value and a minimum value of pixel values. Therefore, it is possible, by the reversible compression, to suppress degradation of image quality for an image including a character or a high-contrast portion. Also, an image formed of only pixels whose pixel values are close, namely, a plain image, is expected of a high compression ratio by the reversible compression, therefore the reversible compression is executed. On the other hand, a natural image that has a small difference between a maximum value and a minimum value of pixel values is compressed at a high compression ratio by the irreversible processing, a compression ratio of data and the image quality are balanced.

Here, in the image data compression apparatus according to the first aspect of the invention, it is preferable that the compression control section causes, for each of plural blocks into which one screen is divided, of the reversible compression processing and the irreversible compression processing, compression processing according to the difference between the maximum value and the minimum value in each block to be executed.

Since optimum compression processing is executed to every block in one screen, a compression ratio of data and the image quality is balanced for the compression of image data in the one screen.

In the image data compression apparatus according to the first aspect of the invention, it is preferable that the reversible compression section includes:
a differential generating section that determines a difference between numeric values adjacent to each other directly or with a certain space therebetween, for a series of numeric values forming the to-be-compressed data, so as to generate new to-be-compressed data made of a series of numeric values expressed in a unit bit number each representing the difference;
an offset section that offsets by a predetermined value each numeric value included in the new to-be-compressed data generated by the differential generating section;
a division section that divides each of numeric values of the to-be-compressed data which are offset by the offset section into a higher-order bit portion and a lower-order bit portion, at a predetermined division bit number smaller than the unit bit number, so as to divide the to-be-compressed data into higher-order data made of a series of higher-order bit portions of the respective numeric values and lower-order data made of a series of higher-order bit portions of the respective numeric values;
a consecutive encoding section that directly outputs, with respect to numeric values except one or plural predetermined compression-targeted numeric values in the higher-order data, and that encodes, with respect to compression target numeric values, the compression target numeric values to the compression target numeric value and a numeric value representing the number of consecutive pieces of a compression target numeric value that is identical to the compression target numeric value, so as to be outputted; and
an entropy encoding section that subjects data after being encoded in the consecutive encoding section to entropy encoding by using a table which associates a corresponding code with a numeric value.

In a case where after obtaining a difference of numeric values adjacent to each other and the data being offset, and then the data is divided into higher-order data and lower-order data, since a frequency of occurrence of a numeric value tends to be unevenly distributed especially in the higher-order data, the higher-order data is subjected to entropy encoding that encodes into a numeric value representing the number of consecutive pieces to be outputted, so that it is possible to improve the compression ratio with the reversible compression.

In the image data compression apparatus according to the first aspect of the invention, it is preferable that the irreversible compression section includes:
a thinning-out processing section that periodically thins out a numeric value from a series of numeric values included in the to-be-compressed data, so as to generate first to-be-compressed data made of a series of numeric values taken out of the to-be-compressed data by the thinning-out and second to-be-compressed data made of a series of remaining numeric values; and
a bit number restriction section that outputs, with respect to numeric values included in the second to-be-compressed data generated by the thinning-out processing section, a numeric value re-expressed in a bit number smaller than a unit bit number.

In the irreversible compression section, by the method in which numeric values from consecutive numeric values are periodically thinned out and remaining consecutive numeric values are re-expressed in a smaller number of bit, it is possible to improve the compression ratio while suppressing the degradation of image quality.

According to a second aspect of the invention, a computer-readable storage medium that stores an image data compression program to perform data compression processing, which is executed in an information processing apparatus, thereby constructing on the information processing apparatus:
a reversible compression section that applies reversible compression processing to to-be-compressed data made of a series of numeric values;
an irreversible compression section that applies irreversible compression processing to to-be-compressed data made of a series of numeric values; and
a compression control section that causes, if a difference between a maximum value and a minimum value in plural pixel values representing plural pixels forming an image is within a range from a predetermined upper limit to a predetermined lower limit, the irreversible compression section to execute the irreversible compression processing for the plural pixel values as the to-be-compressed data, and that causes, if the difference is out of the range, the reversible compression section to execute the reversible compression processing for the plural pixel values as the to-be-compressed data.

As described above, according to the aspects of the present invention, the image data compression apparatus and the storage medium storing the image data compression program that improve the compression ratio of data while suppressing degradation of image quality of a character and line drawing is obtained.

### BRIEF DESCRIPTION OF THE DRAWINGS

FIG. 1 is a configuration diagram of a radiographic image diagnosis system to which one embodiment of the present invention is applied;

FIG. 2 is a block diagram illustrating a hardware configuration of the compression processing section illustrated in FIG. 1;

FIG. 3 is a diagram illustrating a configuration of an image data compression program;

FIG. 4 is a block diagram illustrating the compression processing section illustrated in FIG. 1;

FIG. 5 is a diagram illustrating a screen of data received by a compression control section;

FIG. 6 is a diagram explaining a difference between a maximum value and a minimum value in an image in a block and types of compression processing;

FIG. 7 is a block diagram illustrating an internal configuration of a reversible compression section illustrated in FIG. 4;

FIG. 8 is a diagram illustrating a structure of image data supplied to a differential encoding section;

FIG. 9 is a diagram illustrating a structure of data after the data is subjected to two-dimensional differential encoding processing in the differential encoding section;

FIG. 10 is a diagram illustrating the two-dimensional differential encoding processing in the differential encoding section illustrated in FIG. 7, by way of example;

FIG. 11 is a diagram illustrating an example of histogram of image data supplied from the control section to the differential encoding section;

FIG. 12 is a diagram illustrating an effect of the differential encoding and offset applied to the image data illustrated in FIG. 11;

FIG. 13 is a diagram explaining an effect of a data division by a plane division section;

FIG. 14 is a diagram explaining encoding in a run-length encoding section in FIG. 7;

FIG. 15 is a diagram illustrating an algorithm of encoding that targets to-be-compressed numeric values in the run-length encoding section;

FIG. 16 is a diagram illustrating an example of encoding processing according to the number of consecutive pieces in the run-length encoding section in FIG. 7;

FIG. 17 is a diagram illustrating an example of a scanning result by a data scanning section;

FIG. 18 is a diagram illustrating an example of Huffman table;

FIG. 19 is a diagram illustrating specific examples of code strings prepared in the Huffman table;

FIG. 20 is a diagram illustrating an irreversible compression section illustrated in FIG. 4;

FIG. 21 is a diagram illustrating a concept of thinning-out processing executed by a thinning-out processing section in FIG. 20;

FIG. 22 is a diagram illustrating an encoding scheme into 4-bit code; and

FIG. 23 is a diagram illustrating an example of a data screen divided into blocks differently from those in FIG. 5.

### DETAILED DESCRIPTION OF THE INVENTION

An exemplary embodiment of the present invention will be described with reference to the accompanying drawings.

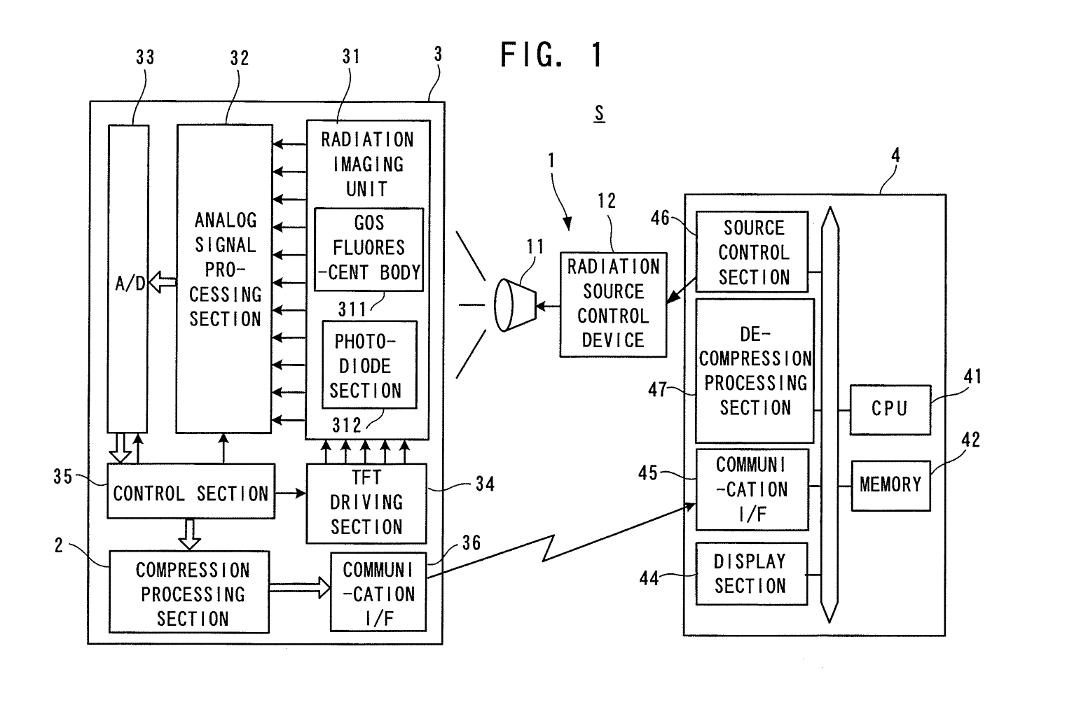

FIG. 1 is a configuration diagram of a radiographic image diagnosis system that is an application of one embodiment of the present application.

A radiographic image diagnosis system S illustrated in FIG. 1 includes a radiation emission apparatus 1, a radiation source control apparatus 12, a radiation detection unit 3, and a system controller 4.

The radiation emission apparatus 1 includes a radiation source 11 to emit X-rays and the radiation source control apparatus 12. Emission of X-rays in the radiation source 11 is controlled by the radiation source control apparatus 12.

The radiation detection unit 3 detects a radiation image according to radiation emitted from the radiation source 11 and passing through a subject, further compresses image data representing the detected radiation image and transmits it wirelessly to the system controller 4.

The system controller 4 decompresses the transmitted compressed data, displays the decompressed image data on a display, and as needed, performs processing necessary for diagnosis to the image data.

The system controller 4 includes a CPU 41, a memory 42, a display section 44, a communication interface (hereafter, interface is abbreviated as I/F) 45, a decompression processing section 47, and a source control section 46, which are connected to each other by a bus.

The CPU 41 executes a program stored in the memory 42 and controls the entire system controller 4 and the radiation detection unit 3. The communication I/F 45 is responsible for wireless communications with the radiation detection unit 3 as described above, and the system controller 4 takes in compressed image data via the communication I/F 45 and transmits an instruction to a control section 35 of the radiation detection unit 3 via the communication I/F 45.

The source control section 46 transmits an instruction about emission of radiation by the radiation source 11 to the radiation source control apparatus 12, and the radiation source control apparatus 12 controls the radiation source 11 according to the received instruction.

The decompression processing section 47 restores the compressed image data transmitted from the radiation detection unit 3 and received via the communication I/F 45 to the image data before the compression. In the above-described memory 42, the received compressed image data and the restored image data are also temporarily stored.

The radiation detection unit 3 includes a radiation imaging unit 31, an analog signal processing section 32, an analog/digital (hereafter, analog/digital is abbreviated as A/D) converter section 33, a thin-film transistor (hereafter, thin-film transistor is abbreviated as TFT) driving section 34, the control section 35, a communication I/F 36, and a compression processing section C.

The radiation imaging unit 31 includes a GOS fluorescent body 311 made of a gadolinium oxide sulfate component (hereafter, gadoliniumoxide sulfate is abbreviated as GOS) and a photodiode section 312 formed for each grid point on a TFT array. The GOS fluorescent body 311 converts the radiation emitted from the radiation source 11 and passing through the subject to visible light according to the magnitude of energy. In the photodiode section 312, the visible light is converted into an electric signal. The analog signal processing section 32 is formed of an operational amplifier for processing the electric signal and a capacitor. The TFT driving section 34 is a switching section and on switch-on, causes the GOS fluorescent body 311 to emit light according to the energy of received radiation and causes the photodiode section 312 to convert the light into an electric signal. The electric signal is taken into the analog signal processing section 32. After processing in the analog signal processing section 32, the signal is converted into digital data in the A/D converter section 33 to be outputted. Image data of the radiation image by the radiation received in the radiation imaging unit 31 is generated in this manner. The image data that is digital data is inputted into the compression processing section C via the control section 35. At this time, the control section 35 adds information including a serial number of shooting to the image data as a character image.

The compression processing section C compresses a data amount of digital data by a means that will be described later in detail, and transmits it wirelessly to a system controller side via the communication I/F 36. The control section 35 causes, following an instruction from the CPU 41 of the system controller 4, the TFT driving section 34, the analog signal processing section 32 and the A/D converter section 33 to be driven, and causes the compression processing section C to apply compression processing, communication I/F 36 to transmit the compressed data and the like.

Next, a flow of operations in the radiographic image diagnosis system S will be described. Incidentally, the following explanation is provided on the understanding that, in performing X-ray shooting for a subject, a user who uses this radiographic image diagnosis system S waits for press-down of switch for emitting X-ray from the radiation source 11 until a display appearing on the display section of the system controller 4 indicating that X-ray shooting is available, after the user has turned on power of each constituent apparatus and made the subject stand at a predetermined stand position.

In the system controller 4, firstly the CPU 41 instructs the control section 35 of the radiation detection unit 3 to grasp a state of each section in the radiation detection unit 3, the control section 35 of the radiation detection unit 3 causes the compression processing section C to determine whether or not it is in a ready state of accepting data, and write a code value representing the state in a register held in the compression processing section C. The control section 35 reads the written code value and when determining that the read code value is of indicating a READY state and if there is no problem in each section except the compression processing section C, the control section 35 transmits a signal indicating that the radiation detection unit 3 is in the READY state to the CPU 41 of the system controller 4. In response to this, the system controller 4 causes a display section 44 to display that shooting is available. Then, the control section 35 of the radiation detection unit 3, after waiting for a notification of shooting execution from the system controller 4, controls each section of the radiation detection unit 3 to detect radiation emitted from the radiation source 11 and passing through the subject, and converts the radiation image to digital data. When the control section 35 inputs one frame of the digital data into the compression processing section C, the control section 35 adds information including a serial number of shooting to the one frame of the digital data as a character image and supplies it to the compression processing section C. Each time completion of data input is detected, the compression processing section C applies compression processing to the image data supplied from the control section 35. The compressed data after being subjected to the compression processing in the compression processing section C is transmitted to the system controller 4 wirelessly by the communication I/F 36.

The compressed data that is transmitted is received by the communication I/F 45 of the system controller 4 and supplied to the decompression processing section 47. The compressed data supplied to the decompression processing section 47 is subjected to decompression processing. The image data after being subjected to the decompression processing is displayed on the display section 44. Additionally, the image data is further subjected to image processing by the CPU 41 as needed.

Next, the compression processing section C of the radiation detection unit 3 will be explained.

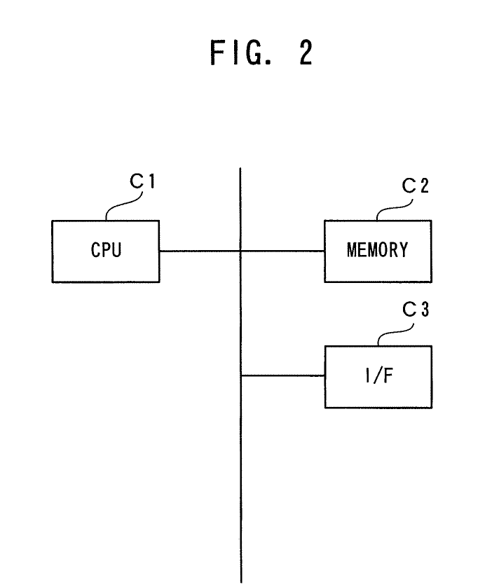

FIG. 2 is a block diagram illustrating a hardware configuration of the compression processing section illustrated in FIG. 1.

The compression processing section C in this embodiment is a computer that includes as hardware, a CPU (C1), a memory (C2) that is a storage medium of programs, and an I/F (C3) that exchanges data with the control section 35 and the communication I/F 36. In the memory (C2), an image data compression program is stored. The image data compression program is read out and executed by the CPU (C1), thereby a function as the compression processing section is obtained. Additionally, in the memory (C2), to-be-processed image data and various types of data as a result of processing are stored as well.

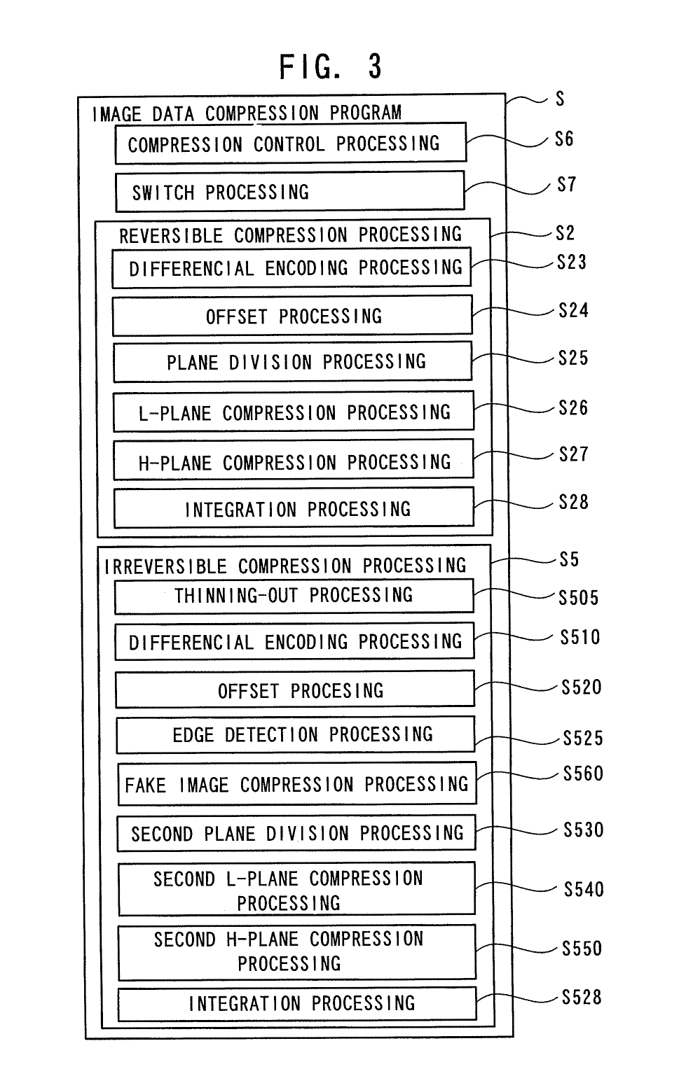

FIG. 3 is a diagram illustrating a configuration of an image data compression program.

An image data compression program S illustrated in FIG. 3 includes a compression control processing section S6, a switch processing section S7, a reversible compression processing section S2, and an irreversible compression processing section S5. The reversible compression processing section S2 causes reversible compression processing to be executed and includes a differential encoding processing section S23, an offset processing section S24, a plane division processing section S25, a L-plane compression processing section S26, a H-plane compression processing section S27, and a frame integration processing section S28. The irreversible compression processing section S5 causes irreversible compression processing to be executed and includes a thinning-out processing section S505, a second differential encoding processing section S510, a second offset processing section S520, an edge detection processing section S525, a FAKE image compression processing section S560, a second plane division processing section S530, a second L-plane compression processing section S540, a second H-plane compression processing section S550, and an integration processing section S528.

By each section of the image data compression program S, each functional block of the compression processing section C that is described hereafter is formed. Operations by the respective sections of the image data compression program S are the same as those of the respective functional blocks of the compression processing section C, and subsequently, each functional block of the compression processing section C will be explained.

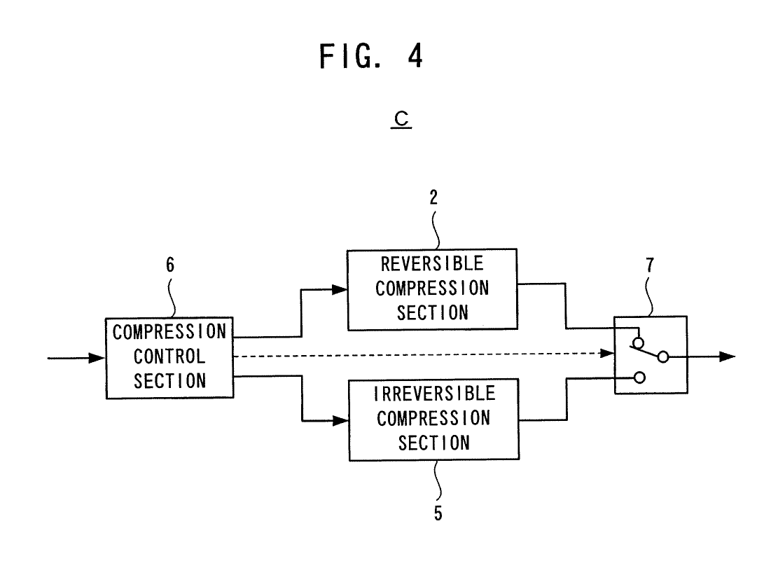

FIG. 4 is a block diagram illustrating the compression processing section illustrated in FIG. 1.

The compression processing section C illustrated in FIG. 4 includes a reversible compression section 2 that applies reversible compression processing to data, an irreversible compression section 5 that applies irreversible compression processing to data, a compression control section 6 that controls compression processing of the reversible compression section 2 and the irreversible compression section 5, and a switch section 7 that switches and outputs data from the reversible compression section 2 and the irreversible compression section 5. The compression control section 6, the switch section 7, the reversible compression section 2, and the irreversible compression section 5 illustrated in FIG. 4 correspond to the compression control processing section S6, the switch processing section S7, the reversible compression processing section S2, and the irreversible compression processing section S5, respectively, of the image data compression program S illustrated in FIG. 3. Here, a combination of the compression control section 6 and the switch section 7 corresponds to one example of the compression control section of the present invention.

The compression control section 6 divides one screen represented by the data received from the control section 35 into plural blocks, searches a maximum value MAX and a minimum value MIN of pixel values for an image in each block and obtains a difference (MAX−MIN) between them.

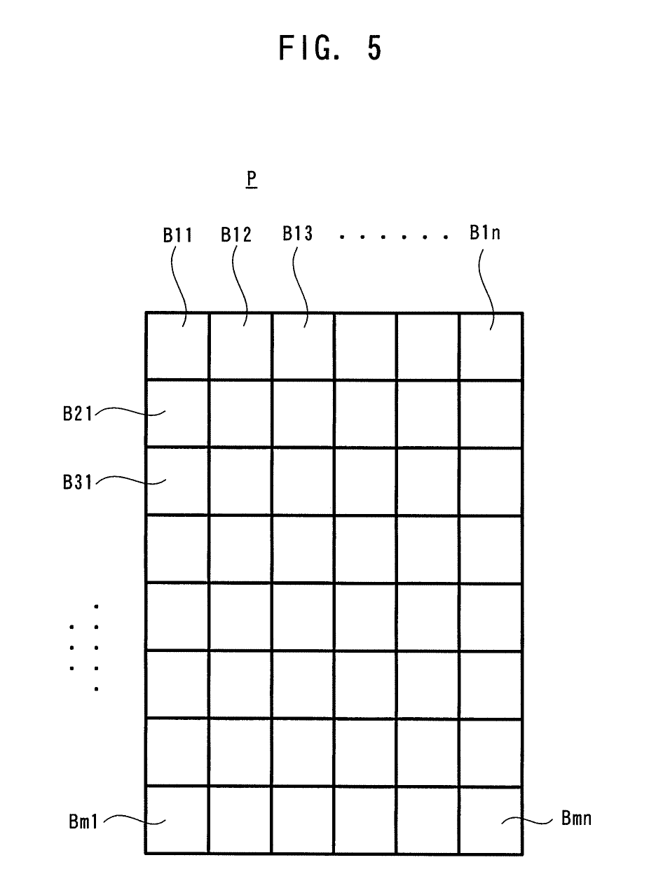

FIG. 5 is a diagram illustrating a screen of data received by the compression control section.

The compression control section 6 divides a received data screen P into plural blocks in M lines×N columns (B11 through Bmn), and obtains, for an image in each block of B11 through Bmn, a difference between a maximum value and a minimum value (MAX−MIN) of pixel values represented in a 16-bit value in each block. The compression control section 6 determines, according to a value of the obtained difference (MAX−MIN), whether the reversible compression section 2 or the irreversible compression section 5 is responsible for applying compression processing to data of each block.

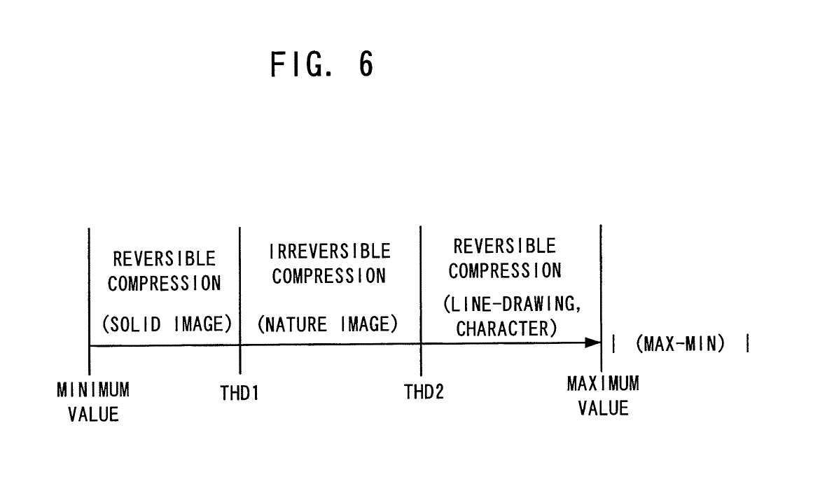

FIG. 6 is a diagram explaining a difference between a maximum value and a minimum value in an image in a block and types of compression processing. The horizontal axis of FIG. 6 denotes a difference between a maximum value and a minimum value (MAX−MIN) in each block.

The difference between the maximum value and the minimum value (MAX−MIN) in each block reflects a type of image in the block. For example, if a certain block only includes pixels whose pixel values are close, for example, plain white or plain black, a difference between a maximum value and a minimum value (MAX−MIN) of the block becomes a minimum possible value as the difference, namely, a value close to “0”. On the contrary, in a case of a block that includes, for example, a mechanically drawn character or line drawing, the block includes a portion where pixel values are substantially large, for example, a white portion, and a portion where pixel values are substantially small like a black portion. Therefore, a difference between a maximum value and a minimum value (MAX−MIN) becomes a value that is close to a maximum possible value as the difference. Also, pixel values of pixels in a natural image such as an image by X-ray photographing or in a block that is a portion cut out form the natural image are distributed in a certain range, and the difference between the maximum value and the minimum value (MAX−MIN) is mainly distributed in a range of medium values in between the maximum value and the minimum value, for example, between a first threshold value THD1 and a second threshold value THD2. However, among the blocks, there may be a block made of so-called solid fills, including only pixels whose pixel values are close.

The compression control section 6 causes the irreversible compression section 5 to execute the irreversible compression processing by using the pixel values in a block as to-be-compressed data, if a difference between the maximum value and the minimum value (MAX−MIN) in the block falls within the range of the first threshold value THD1 and the second threshold value THD2. On the other hand, if the difference between the maximum value and the minimum value (MAX−MIN) in the block is out of the range of the first threshold value THD1 and the second threshold value THD2, namely, smaller than the first threshold value THD1 or larger than the second threshold value THD2, the compression control section 6 causes the reversible compression section 2 to execute the reversible compression processing by using the pixel values in the block as to-be-compressed data. Furthermore, the switch section 7 selects an output selected by the compression control section 6 out of the reversible compression section 2 and the irreversible compression section 5, and outputs it to the communication I/F 36 (see FIG. 1).

Although details of the compression processing by the reversible compression section 2 and the irreversible compression section 5 will be described later, in the irreversible compression section 5, while the compression ratio is improved compared to the reversible compression section by the reversible compression section 2, the compressed data is not perfectly restored even by decompression processing. Because of this, in a portion where a character is included or contrast is high, blurring and halation occur after the decompression processing and degradation of the image is evident. As for an image in a block including a character or the like, since the reversible compression processing is selected by the compression control section 6, there is no blurring and halation in the image after the decompression processing and thus a high image quality is maintained. On the other hand, as for an image in a block cut out from a natural image, since blurring and halation after the decompression processing is inconspicuous, the irreversible compression processing in which the compression ratio is high is selected. Further, as for a plain image of the block cut out from the natural image, since a high compression ratio is expected with the reversible compression processing and also a change of pixel values is often conspicuous if restoring is not completely performed, the reversible compression processing is selected.

In this way, according to the compression processing section C, the compression ratio of data and the image quality is balanced.

The data outputted from the compression processing section C is transferred to a decompression processing section of the system controller 4 via the communication I/F 36 and the communication I/F 45 of the system controller 4 illustrated in FIG. 1, and data decompression processing is applied to the compressed data. At the time of this data decompression processing, decode processing corresponding to each of various types of encode processing is applied to obtain image data.

Subsequently, each compression processing of the reversible compression section 2 and the irreversible compression section 5 will be explained.

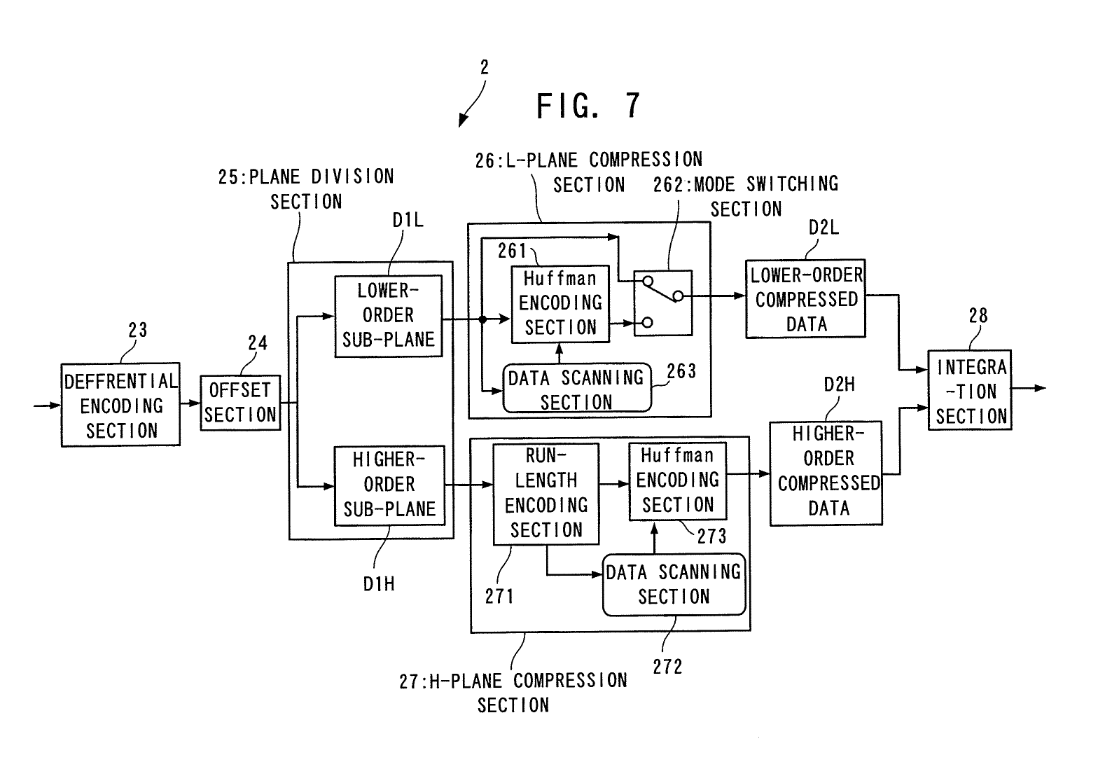

FIG. 7 is a block diagram illustrating an internal configuration of the reversible compression section illustrated in FIG. 4.

The reversible compression section 2 illustrated in FIG. 7 executes reversible compression processing capable of completely restoring original data before the compression when it is decompressed. The reversible compression section 2 includes a differential encoding section 23, an offset section 24, a plane division section 25, a L-plane compression section 26, a H-plane compression section 27, and a frame integration section 28. The differential encoding section 23, the offset section 24, the plane division section 25, the L-plane compression section 26, the H-plane compression section 27, and the frame integration section 28 illustrated in FIG. 7 correspond to the differential encoding processing section S23, the offset processing section S24, the plane division processing section S25, the L-plane compression processing section S26, the H-plane compression processing section S27, and the frame integration processing section 28, respectively, of the image data compression program S illustrated in FIG. 3.

To the differential encoding section 23, image data in a bitmap format each of whose pixel is expressed in a 16-bit value is supplied from the compression control section 6 (see FIG. 4). However, from the compression control section 6, among the blocks into which a screen is divided, image data is supplied for a portion corresponding to a block that is selected to be subjected to the reversible compression. The differential encoding section 23 temporarily stores data of a line that is received last time in a not-illustrated buffer and encodes while referring to this stored data as well. In the differential encoding section 23, a two-dimensional differential encoding processing, that is, a process in which, for the consecutive numeric values forming the inputted data, a two-dimensional difference is obtained based on plural numeric values adjacent to a numeric value in interest in plural directions respectively when viewed on the image is obtained, to generate image data made of consecutive 16-bit numeric values representing the differences is performed.

In the offset section 24, the image data made of consecutive numeric values representing the differences, generated in the differential encoding section 23 is offset by a predetermined offset value.

In the plane division section 25, each numeric value of the image data after the offset is divided into lower-order 8 bits and higher-order 8 bits, so that the image data is divided into a lower-order sub-plane D1L made of consecutive numeric values in lower-order bit and a higher-order sub-plane D1H made of consecutive numeric values in higher-order bit.

In the L-plane compression section 26 and the H-plane compression section 27, reversible compression is applied to each of the lower-order sub-plane D1L and the higher-order sub-plane D1H which are divided by the plane division section 25.

The frame integration section 28 combines a lower-order compressed data D2L and a higher-order compressed data D2H outputted from the L-plane compression section 26 and the H-plane compression section 27, respectively, to generate a frame serving as a unit of data transmission. The frame constitutes compressed data with respect to original image data.

Here, the differential encoding section 23 corresponds to one example of the differential generating section according to the present invention, the offset section 24 corresponds to one example of the offset section according to the present invention, and the plane division section 25 corresponds to one example of the plane division section according to the present invention.

Firstly, a flow of compression of image data in the reversible compression section 2 will be explained.

As previously described, the image data that is transmitted from the compression control section 6 (see FIG. 4) and in which each pixel is expressed in a 16-bit value, is subjected to the two-dimensional differential encoding in the differential encoding section 23, offset by the offset section 24, and then divided into lower-order 8-bit and higher-order 8-bit in the plane division section 25, thereby the image data is divided into the lower-order sub-plane D1L made of consecutive numeric values in lower-order bit and the higher-order sub-plane D1H made of consecutive numeric values in higher-order bit.

The L-plane compression section 26 includes a Huffman encoding section 261, a mode switching section 262 to switch the mode to either of a high-speed mode or a normal mode, and the data scanning section 263. The lower-order sub-plane D1L inputted from the plane division section 25 is inputted into both of the data scanning section 263 and the Huffman encoding section 261 of the L-plane compression section 26.

In the data scanning section 263, all the data of the lower-order sub-plane D1L or a part of the data that is thinned out is scanned and frequencies of occurrence (histogram) for all numeric values occurring in the data are determined. Here, in the present embodiment, processing of obtaining the frequencies of occurrence is performed for each lower-order sub-plane D1L illustrated in FIG. 7 as a unit, and frequencies of occurrence of numeric values in the data, of each lower-order sub-plane D1L are obtained.

In addition, the data scanning section 263 allocates a code with a shorter length to a numeric value with a greater frequency of occurrence in the Huffman table, based on the obtained data histogram (frequencies of occurrence of numeric values). In this way, the Huffman table in which numeric values and codes are associated is updated by the data scanning section 263.

The Huffman table in which codes are allocated to numeric values by the data scanning section 263 is passed to the Huffman encoding section 261. Subsequently, the Huffman encoding section 261 of the L-plane compression section 26 performs encoding processing to replace numeric values that make up of the lower-order sub-plane D1L inputted into the Huffman encoding section 261 with codes according to the passed Huffman table.

The mode switching section 262 in the L-plane compression section 26 is given an instruction from an user to switch between the high-speed mode and the normal mode, and switching is performed between the normal mode that goes through Huffman encoding by the Huffman encoding section 261 and the high-speed mode that omits the Huffman encoding and directly outputs the lower-order sub-plane D1L. Accordingly, finally from the L-plane compression section 26, in the normal mode, the lower-order compressed data D2L in which the lower-order sub-plane D1L is compressed by the Huffman encoding is outputted, whereas in the high-speed mode, the lower-order compressed data D2L in which the Huffman encoding is not applied is outputted.

The H-plane compression section 27 includes a run-length encoding section 271, a data scanning section 272, and a Huffman encoding section 273. The higher-order sub-plane D1H inputted from the plane division section 25 is inputted into the run-length encoding section 271 of the H-plane compression section 27.

In the run-length encoding section 271 in the H-plane compression section 27, for the inputted higher-order sub-plane D1H, encoding is performed in which, according to the number of consecutive pieces of an identical to-be-compressed numeric value, the number of consecutive pieces is expressed in a different bit. Here, specifically, when the number of consecutive pieces of the identical to-be-compressed numeric value is equal to or less than a predetermined number, the number of consecutive pieces is expressed in a bit number in 1 unit, whereas when the number of consecutive pieces is more than the predetermined number, the number of consecutive pieces is expressed in a bit in 2 unit. The data encoded in the run-length encoding section 271 is subsequently inputted into both of the data scanning section 272 and the Huffman encoding section 273.

In the data scanning section 272, all the data after being encoded by the run-length encoding section 271 or a part of the data that is thinned out is scanned and frequencies of occurrence (histogram) for all numeric values occurring in the data are determined. Here, in the present embodiment, processing of obtaining the frequencies of occurrence is performed for each higher-order sub-plane D1H illustrated in FIG. 7 as a unit, and frequencies of occurrence of numeric values in the data after being encoded by the run-length encoding section 271, of each higher-order sub-plane D1H are obtained.

In addition, the data scanning section 272 allocates, based on the obtained data histogram (frequencies of occurrence of numeric values), a code with a shorter code length for numeric value with a greater frequency of occurrence. In this way, the Huffman table in which numeric values and codes are associated is updated by the data scanning section 272.

The Huffman table in which codes are allocated to numeric values by the data scanning section 272 is passed to the Huffman encoding section 273. The Huffman encoding section 273 performs encoding processing to replace numeric values of the data inputted into the Huffman encoding section 273 with codes according to the Huffman table, i.e., a code in which a numeric value with a greater frequency of occurrence is expressed in a shorter bit length.

Here, the run-length encoding section 271 corresponds to an example of the consecutive encoding section according to the present invention, and the Huffman encoding section 273 corresponds to an example of the entropy encoding section according to the present invention.

The data after Huffman-encoded in the Huffman encoding section 273 is accompanied with compression information including an allocation table of the numeric values and codes allocated by the data scanning section 272 and outputted from the H-plane compression section 27 as the higher-order compressed data D2H in which the higher-order sub-plane D1H is compressed.

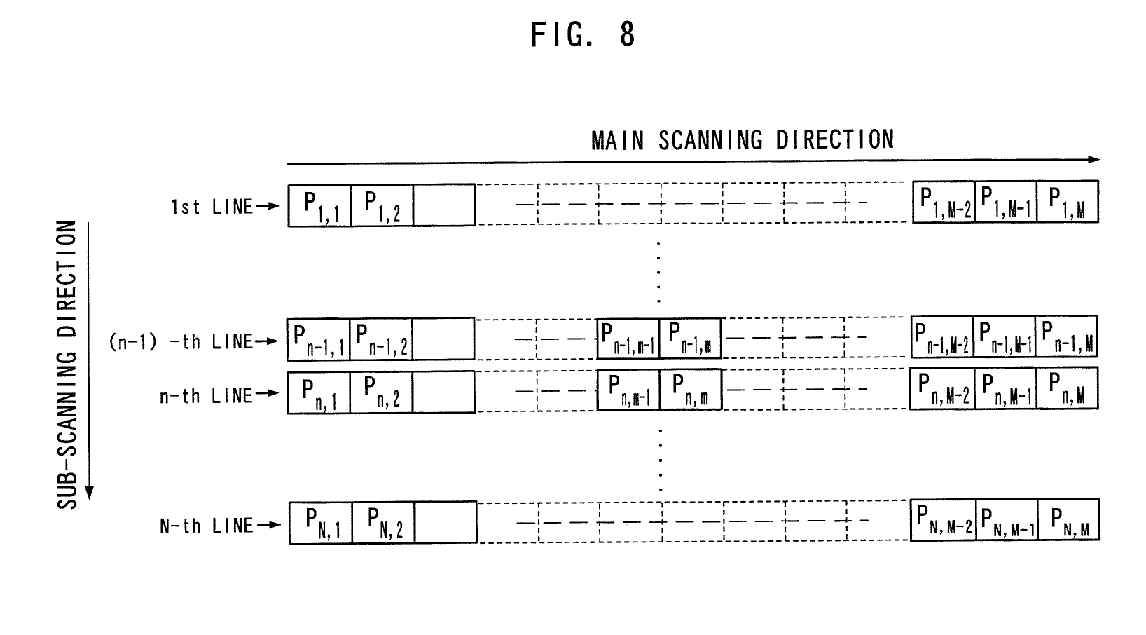

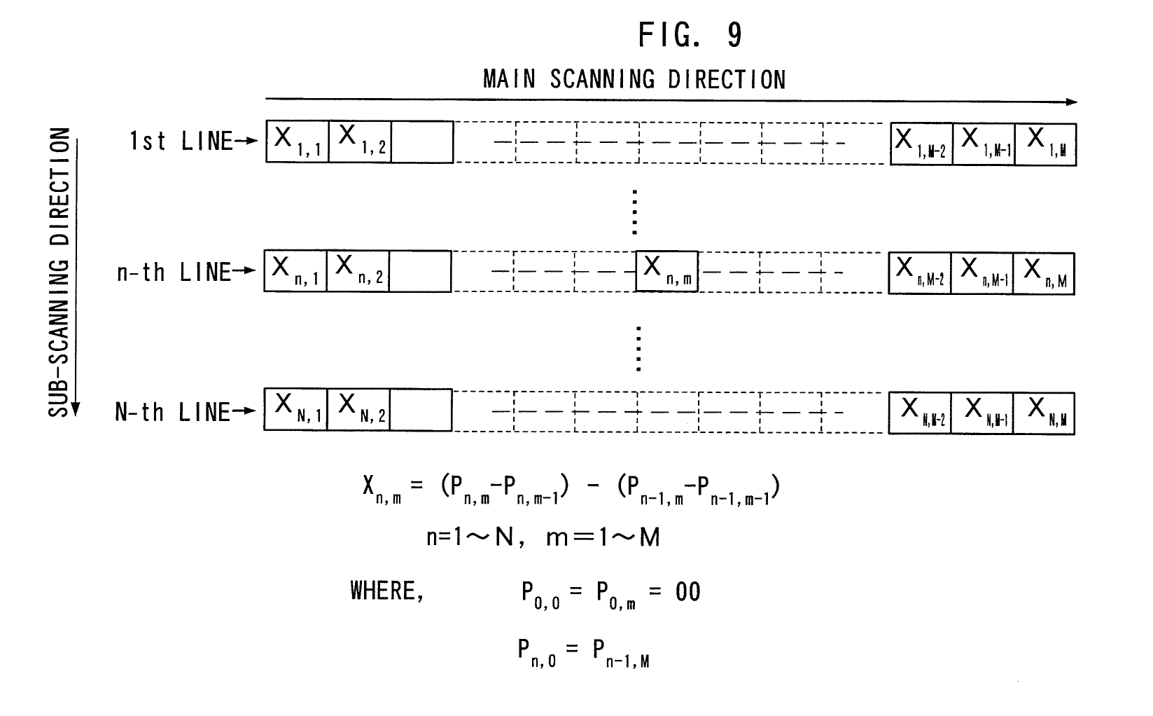

FIG. 8 is a diagram illustrating a structure of image data supplied to the differential encoding section, and FIG. 9 is a diagram illustrating a structure of the data after being subjected to the two-dimensional differential encoding processing in the differential encoding section.

An image represented by image data supplied from the control section 35 has such a configuration that N lines, each of which is made up of M pixels aligned in a predetermined main scanning direction, are aligned in a sub scanning direction orthogonal to the main scanning direction. The image data reflects such a configuration and thus also is configured such that N lines, each of which is made up of M pixel values aligned in the main scanning direction (a lateral direction in the diagram), are aligned in the sub scanning direction (a vertical direction in the diagram) as illustrated in FIG. 8. In this diagram, the m-th pixel value from left in the n-th line from the top is denoted by P_{n,m}. By using this notation, in the line at the n-th position in the sub-scanning direction, pixel values of the respective pixels aligned in the main scanning direction are denoted in the alignment order: P_{n,1}, P_{n,2}, . . . , P_{n,m-1}, P_{n,m}, . . . , P_{n,M-2}, P_{n,M-1}, P_{n,M}. These pixel values are numeric values expressed in hexadecimal notation.

Here, the image data described above is inputted into the differential encoding section 23 illustrated in FIG. 7, where the image data is subjected to the two-dimensional differential encoding processing, to obtain a further difference in the sub-scanning direction as to the differences between pixels adjacent to each other in the main scanning direction.

FIG. 9 illustrates the structure of the data after being subjected to the two-dimensional differential encoding processing. This data also has such a configuration that N lines, each of which is made up of M pixel values after the two-dimensional differential encoding, are aligned in the main scanning direction. In FIG. 9, the m-th pixel value, from left in the n-th line from the top, after being subjected to the two-dimensional differential encoding, is denoted in X_{n,m}. This pixel value X_{n,m} after the two-dimensional differential encoding is obtained from four pixel values (P_{n-1,m-1}, P_{n-1,m}, P_{n,m-1}, P_{n,m}) before the two-dimensional differential encoding illustrated in a central part of FIG. 8, based on a conversion formula shown below.

X_{n,m}=(P_{n,m}−P_{n-1,m})−(P_{n-1,m}−P_{n-1,m-1}) (1)

Here, in a case of n=1 or m=1, 0 appears as the subscript of the pixel value before the two-dimensional differential encoding on the right side. The pixel value whose subscript is 0 is defined as follows.

P_{0,0}=P_{0,m}=0000 (m=1 to M), P_{n,0}=P_{n-1,M}, (n=1 to N) (2)

Here, “0000” of the formula (2) indicates that the value is zero when the pixel value is expressed in hexadecimal notation. In the following, the meanings of the formula (1) and the formula (2) will be briefly described.

The formula (1) indicates that the pixel value X_{n,m} after the two-dimensional differential encoding is obtained by the further difference, in the sub-scanning direction, of the difference (i.e., a value in the parenthesis) between pixels adjacent to each other in the main scanning direction. When the correlation between the pixel value P_{n,m} before the two-dimensional differential encoding and its adjacent pixel value is strong (i.e., when these pixel values are similar to each other in terms of size), the pixel value X_{n,m} after the two-dimensional differential encoding is close to zero.

The formula (2) represents the definition of each pixel value when a virtual 0th line in the sub-scanning direction and a virtual pixel value at the 0th position from left in each line are newly provided. In this definition, as to the main scanning direction, the pixel value at the left edge (the 0th pixel value P_{n,0} from left) and the pixel value P_{n-1,M} at the right edge in a line before the line where the pixel value at the left edge is present are regarded as identical. Further, in this definition, as to the sub-scanning direction, the uppermost pixel value in the diagram (the pixel value in the 0th line), namely P_{0,0} and P_{0,m} are fixed to 0.

In the data after the two-dimensional differential encoding, as to the pixel value in the first line and the first pixel value in each line, a term where a subscript is “0” appears in the right side of the conversion formula (1). Therefore, the definition of the formula (2) is applied. To be more specific, the pixel value in the first line after the two-dimensional differential encoding is expressed as shown below based on the formula (1) and the formula (2).

$${X}_{1 , 1} = {P}_{1 , 1} , \\ {X}_{1 , 2} = {P}_{1 , 1} - {P}_{1 , 1} , \\ {X}_{1 , 3} = {P}_{1 , 3} - {P}_{1 , 2}$$

$$…$$

$${X}_{1 , M} = {P}_{1 , M} - {P}_{1 , M - 1}$$

On the other hand, in the data after the two-dimensional differential encoding, the first pixel value of each line is expressed as shown below based on the formula (2).

$${X}_{1 , 1} = {P}_{1 , 1} , \\ {X}_{2 , 1} = ( {P}_{2 , 1} - {P}_{1 , M} ) - {P}_{1 , 1} , \\ {X}_{3 , 1} = ( {P}_{3 , 1} - {P}_{2 , M} ) - ( {P}_{2 , 1} - {P}_{1 , M} ) , \\ …$$

$${X}_{N , 1} = ( {P}_{N , 1} - {P}_{N - 1 , M} ) - ( {P}_{N - 1 , 1} - {P}_{N - 2 , M} )$$

In this way, as to the pixel value in the first line and the first pixel value in each line, the way of the conversion is slightly peculiar. However, to the pixel values other than these pixel values, the formula (1) is directly applied without the definition of the formula (2) being applied. For example, the pixel values except the pixel value at the left edge among the pixel values in the second line are each expressed as shown below.

$${X}_{2 , 2} = ( {P}_{2 , 2} - {P}_{2 , 1} ) - ( {P}_{1 , 2} - {P}_{1 , 1} ) , \\ {X}_{2 , 3} = ( {P}_{2 , 3} - {P}_{2 , 2} ) - ( {P}_{1 , 3} - {P}_{1 , 2} ) , \\ …$$

$${X}_{2 , M} = ( {P}_{2 , M} - {P}_{2 , M - 1} ) - ( {P}_{1 , M} - {P}_{1 , M - 1} )$$

This two-dimensional differential encoding processing will be described using concrete numeric values.

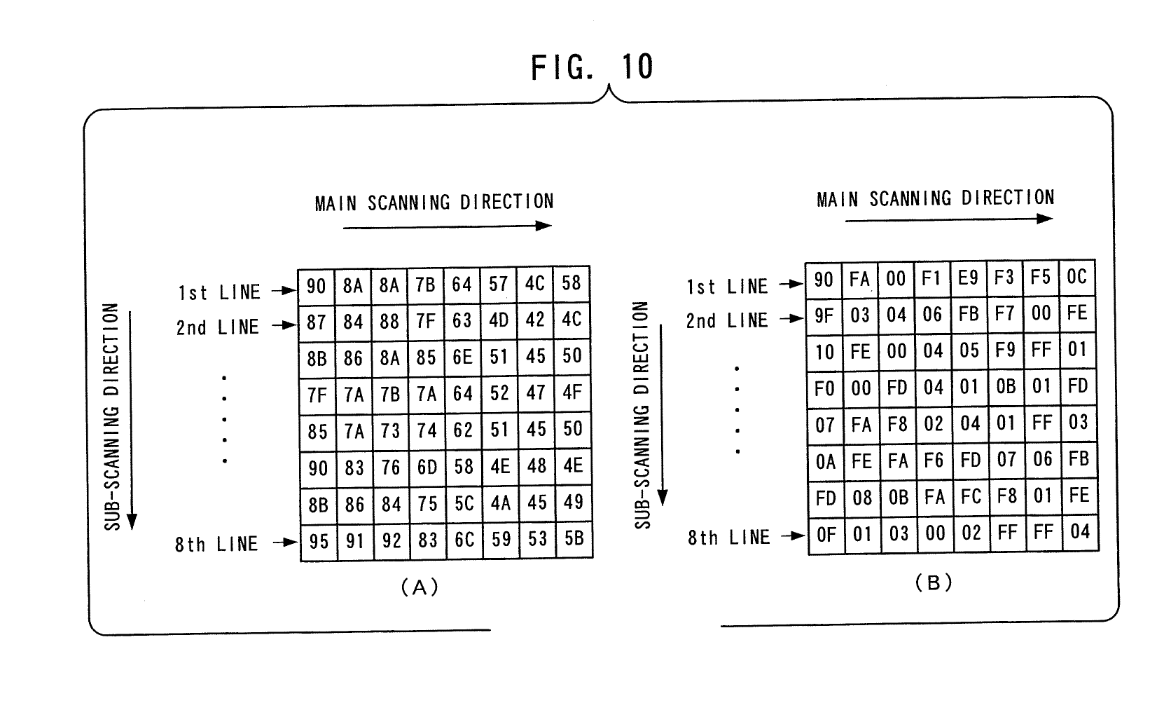

FIG. 10 is a diagram illustrating the two-dimensional differential encoding processing in the differential encoding section in FIG. 7, by way of example.

Each numeric value illustrated on the left side of FIG. 10 (part (A)) is a pixel value of image data, whereas each numeric value illustrated on the right side of FIG. 10 (part (B)) is an output value that is outputted by the two-dimensional differential encoding processing. The lateral direction in FIG. 10 is the main scanning direction, and a row formed by eight numeric values aligned along the main scanning direction is the above-described line. The data illustrated in FIG. 10 includes eight lines in total, each having such eight numeric values aligned therein. This data is equivalent to data in a case where N=8, M=8 in the data in FIG. 8 and FIG. 9. Incidentally, although the differential encoding section 23 in the present embodiment processes a value in 16 bits as data representing one pixel of image data, here, to avoid difficulty in recognizing the value, explanation will be made by the example of a value in 8 bits as data representing one pixel.

In the two-dimensional differential encoding processing applied to the data illustrated in part (A) of FIG. 10, at first, the leftmost “90” among pixel values “90 8A 8A 7B . . . ” in the first line is directly output as the above-mentioned X_{1,1} and as the remaining X_{1,2}, X_{1,3} and so on, differential values “8A−90=FA”, “8A−8A=00” and so on between pixel values adjacent to each other in the main scanning direction are output. Here, actually, the result of subtracting “90” from “8A” becomes a negative number and is represented by “1FA” in 9 bits. However, the higher-order “1” that is 1 bit of MSB is omitted, and only “FA” corresponding to lower-order 8 bits is outputted.

As to the second line, in the following formula to determine X_{2,1},

X_{2,1}=(P_{2,1}−P_{1,M})−P_{1,1}

where the numeric values illustrated in part (A) of FIG. 10 are substituted into (P_{2,1}, P_{1,8}, P_{1,1}) with defined as M=8 in in the right side, and “(87−58)−90=9F” is outputted as X_{2,1}. As the remaining X_{2,2}, X_{2,3}, differences “(84−87)−(8A−90)=3”, “(88−84)−(8A−8A)=04”, . . . between the differences between the pixel values adjacent to each other in the main scanning direction in the second line and the differences between the pixel values adjacent to each other in the main scanning direction in the first line are outputted.

As to the third line, in the following formula to determine X_{3,1},

X_{3,1}=(P_{3,1}−P_{2,M})−(P_{2,1}−P_{1,M})

where the numeric values illustrated in part (A) of FIG. 10 are substituted into {P_{3,1}, P_{2,8}, P_{2,1}, P_{1,8}} with defined as M=8 in the right side, and “(8B−4C)−(87−58)=10” is outputted as X_{3,1}. As the remaining X_{3,2}, X_{3,3}, . . . , differences “(86−8B)−(84−87)=FE”, “(8A−86)−(88−84)=00”, . . . , between the differences between the pixel values adjacent to each other in the main scanning direction in the third line and the differences between the pixel values adjacent to each other in the main scanning direction in the second line are outputted.

As to the fourth line and thereafter as well, each numeric value illustrated in part (B) of FIG. 10 is obtained by repeating the operation same as that for the third line.

Incidentally, in the decompression processing section 47 illustrated in FIG. 1, the data that has undergone the two-dimensional differential decoding in this way is subjected to the decoding processing. In this decoding processing, a formula to determine P_{n,m} from the data after being subjected to the two-dimensional differential decoding is used, and this formula is obtained as follows.

A result of performing addition in the pixel value X_{i,j} after the two-dimensional differential encoding, from i=1 to i=m and further from j=1 to j=m, is expressed as the following formula (3), by using the formula (1) and the formula (2).

$$\begin{matrix}{\sum }_{i = 1}^{n} {\sum }_{j = 1}^{m} {X}_{i , j} = {\sum }_{i = 1}^{n} \{ {\sum }_{j = 1}^{m} ( {p}_{i , j} - {p}_{i , j - 1} ) - {\sum }_{j = 1}^{m} ( {p}_{i , j} - {p}_{i - 1 , j - 1} ) \} \\ = {\sum }_{i = 1}^{n} \{ ( {P}_{i , m} - {P}_{i , 0} ) - ( {P}_{i - 1 , m} - {P}_{i - 1 , 0} ) \} \\ = {\sum }_{i = 1}^{n} \{ ( {P}_{i , m} - {P}_{i - 1 , m} ) - ( {P}_{i , 0} - {P}_{i - 1 , 0} ) \} \\ = ( {P}_{n , m} - {P}_{0 , m} ) - ( {P}_{n , 0} - {P}_{0 , 0} ) \\ = {P}_{n , m} - {P}_{n - 1 , M}\end{matrix} \qquad ( 3 )$$

Here, to {P_{0,0}, P_{n,0}, P_{0, m}} appearing in the middle of the formula, the formula (2) is applied. Based on this formula, the pixel value P_{n,m} before the two-dimensional differential encoding is expressed as the following formula (4).

$${P}_{n , m} = {\sum }_{i = 1}^{n} {\sum }_{j = 1}^{m} {X}_{i , j} + {P}_{n - 1 , M} \qquad ( 4 )$$

In the decompression processing section 47, at first, the pixel value P_{1,1}, P_{1,2}, . . . , P_{1,M} in the first line are determined by the formula (4). For example, by substituting n=1 into the formula (4) and further using P_{0,M}=0, the m-th pixel value in the main scanning direction among the pixel values in the first line is represented by the following formula (5).

$${P}_{1 , m} = {\sum }_{j = 1}^{m} {X}_{1 , j} \qquad ( 5 )$$

In this way, the pixel values P_{1,1}, P_{1,2}, . . . , P_{1,M} in the first line are all determined.

The pixel values P_{2,1}, P_{2,1}, . . . , P_{2,M} are obtained similarly by substituting n=2 into the formula (4) and using P_{1,M} obtained by the decoding of the pixel values in the first line. For example, the m-th pixel value in the main scanning direction among the pixel values in the second line is expressed by the following formula (6).

$${P}_{2 , m} = {\sum }_{j = 1}^{m} ( {X}_{1 , j} + {X}_{2 , j} ) + {P}_{1 , M} \qquad ( 6 )$$

The pixel values in the third line and thereafter also are similarly determined by using the pixel values decoded by the formula (6) and the computation thereafter. In the decompression processing section 47 illustrated in FIG. 1, the decoding processing of data is performed in this way.

In the differential encoding section 23 in FIG. 7, image data is subjected to the two-dimensional differential encoding as described above. The data obtained by this two-dimensional differential encoding is inputted into the offset section 24 in FIG. 7, an offset value of “0x0080” is added to each numeric value of the data, and the data is divided into the lower-order sub-plane D1L and the higher-order sub-plane D1H. Here, processing up to the division of the data will be described in detail.

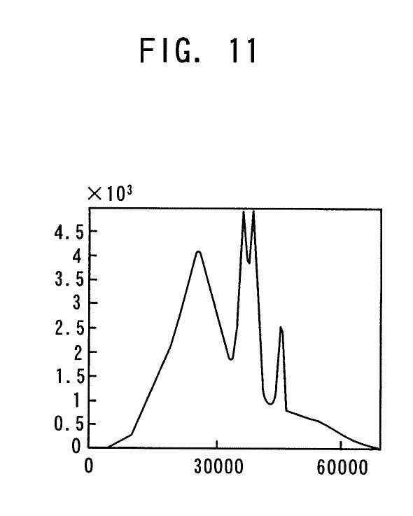

FIG. 11 is a diagram illustrating an example of histogram of image data supplied to the differential encoding section from the control section. In FIG. 11, a histogram of data values in the image data supplied from the control section 35 (FIG. 1) is illustrated, and the horizontal axis of this histogram denotes the data value, while the vertical axis denotes the number of pieces of data (the number of pixels).

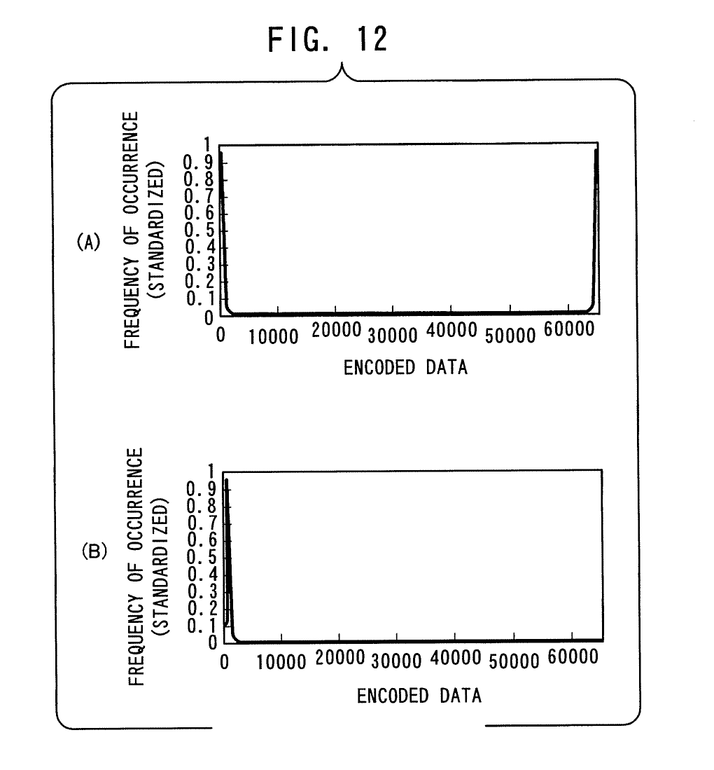

FIG. 12 is a diagram illustrating effects of the differential encoding and the offset for the image data illustrated in FIG. 11.

In part (A) of FIG. 12, there is illustrated a histogram of data obtained by subjecting the image data illustrated in FIG. 11 to the differential encoding. The horizontal axis of this histogram denotes the data value, while the vertical axis denotes the frequency of occurrence. This diagram illustrates a state when the image data is subjected to the differential encoding, the histogram of the data has a sharp peak at each of the minimum data value and the maximum data value. And, when such data is offset by an offset value of “0x008”, the histogram of the data has a sharp peak at the offset value of “0x0080” as illustrated in part (B) of FIG. 12. (In this case, the offset value of “0x0080” is 16-bit data and in a case in which the offset value is 8-bit data, the histogram of the data has a sharp peak at an offset value of “0x08”.) The data whose histogram is transformed by the differential encoding and the offset in this way is divided into the lower-order sub-plane D1L and the higher-order sub-plane D1H by the plane division section 25 illustrated in FIG. 7.

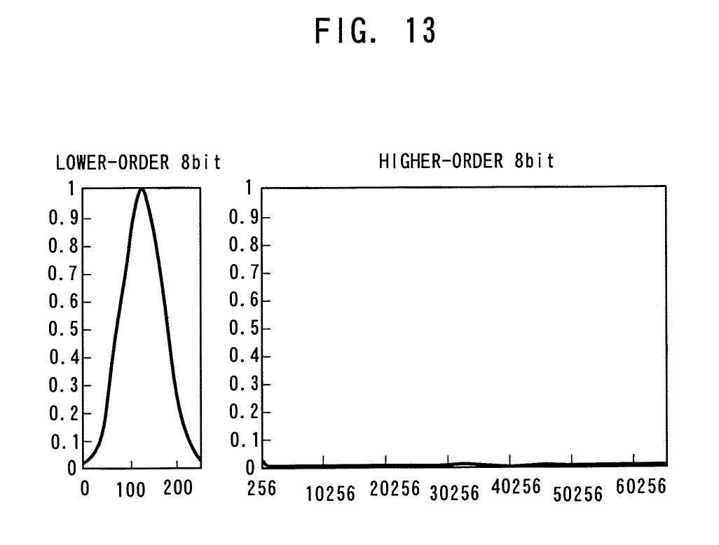

FIG. 13 is a diagram explaining an effect of the data division by the plane division section.

FIG. 13 illustrates a histogram obtained by dividing the histogram illustrated in part (B) of FIG. 12 between the data value “255” and the data value “256”. The data division by the plane division section 25 in FIG. 7 produces an effect equivalent to this division of the histogram. In other words, in the present embodiment, each of 16-bit numeric vales forming the data is divided into higher-order 8 bits and lower-order 8 bits, so that there are obtained the lower-order sub-plane D1L made up of consecutive numeric values represented by the lower-order 8 bits and the higher-order sub-plane D1H made up of consecutive numeric values represented by the higher-order 8 bits. Further, when it is interpreted that the 8-bit numeric values of the lower-order sub-plane D1L directly represent the numeric values from “0” to “255”, and the 8-bit numeric values of the higher-order sub-plane D1H represent numeric values from “256” to “65535”, the histogram of the lower-order sub-plane D1L is almost same as the histogram illustrated on the left side in FIG. 13, and the histogram of the higher-order sub-plane D1H is almost same as the histogram illustrated on the right side in FIG. 13. However, in the histogram of the higher-order sub-plane, a peak having a height equal to an area of the histogram illustrated on the left side in FIG. 13 is added at the data value “256” of the histogram illustrated on the right side.

In the following, processing of the data after being divided into the higher-order sub-plane D1H and the lower-order sub-plane D1L will be described.

First, the processing for the higher-order sub-plane D1H illustrated on the right side in FIG. 13 will be described.

As apparent from that the frequencies of occurrence of the pixels in the histogram illustrated on the right side in FIG. 13 are almost zero, it is expected that most of the numeric values of the higher-order sub-plane D1H are consecutive values near zero (“00” and “01” and “FF” in hexadecimal notation). For this reason, in order to compress the higher-order sub-plane D1H, it is effective to perform run-length encoding in which compression is performed by encoding identical consecutive numeric values, and the higher-order sub-plane D1H is inputted into the run-length encoding section 271 that is one of the constituent elements of the H-plane compression section 27 illustrated in FIG. 7.

In the present embodiment, consecutive 8-bit numeric values of the higher-order sub-plane D1H are treated in the run-length encoding section 271, and consecutive numeric values from values “00” to “FF” in hexadecimal notation are subjected to the following encoding processing.

In this encoding processing, only a particular numeric value of plural 8-bit numeric values is encoded. Therefore, in this run-length encoding section 271, a numeric value targeted for the encoding processing (here, this numeric value is referred to as a “to-be-compressed numeric value”) and the number of consecutive pieces of the to-be-compressed numeric values is detected from the received data.

In the present embodiment, for instance, three numeric values of “01”, “FF” and “00” are used as the to-be-compressed numeric value.

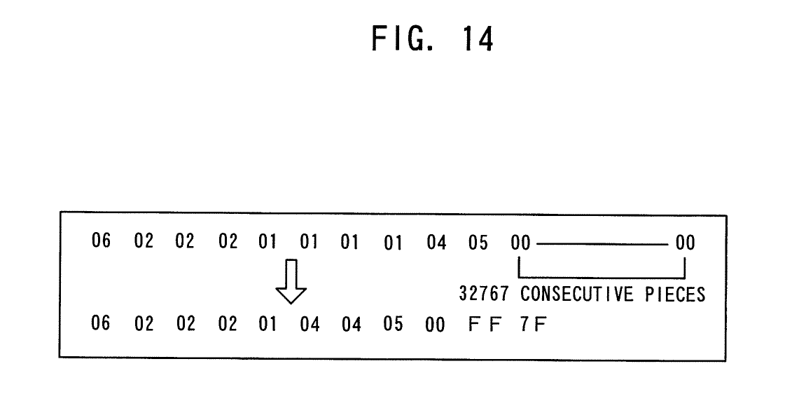

FIG. 14 is a diagram explaining the encoding in the run-length encoding section illustrated in FIG. 7.

The upper line in FIG. 14 represents data of the higher-order sub-plane D1H, and the lower line represents data after being subjected to the encoding processing in the run-length encoding section 271.

Here, as illustrated in the upper line in FIG. 14, the data made up of “06 02 02 02 01 01 01 01 04 05 00 . . . ” is assumed to be inputted from the run-length encoding section 271. At this time, in the run-length encoding section 271 in FIG. 7, there are detected: the head “06” as well as the following “02 02 02” as not being the to-be-compressed numeric values; the subsequent four consecutive pieces of “01” as being the to-be-compressed numeric values; and subsequently, after “04” and “05”, consecutive 32767 pieces of “00” as being the to-be-compressed numeric values.

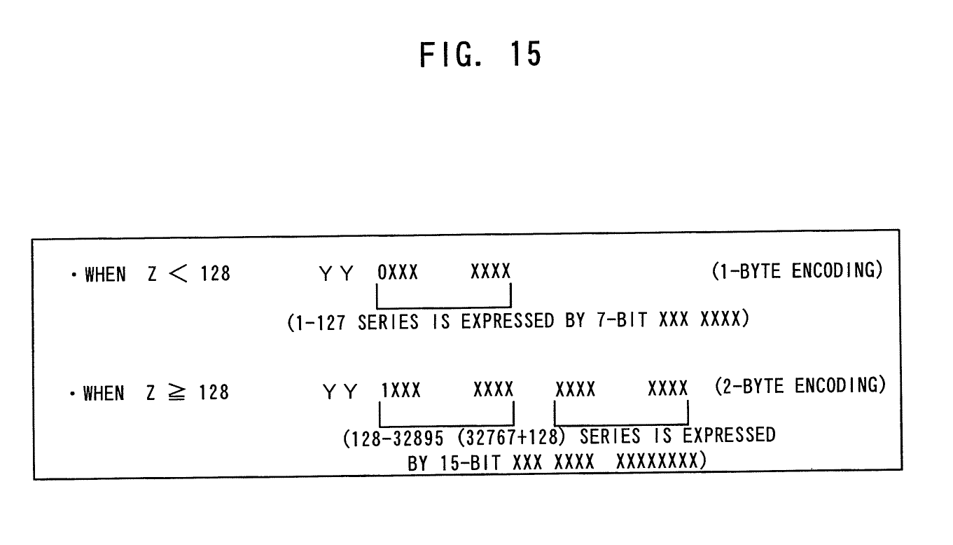

FIG. 15 is a diagram illustrating an algorithm of the encoding that targets the to-be-compressed numeric values in the run-length encoding section.

In FIG. 15, “Z” represents the number of consecutive pieces of an identical to-be-compressed numeric value. For example, in the upper line in FIG. 14, Z=4 for “01”, and Z=32767 for “00”.

Further, in FIG. 15, “YY” represents the to-be-compressed numeric value in two-digit hexadecimal notation. Following “YY,” “0” or “1” is “0” or “1” expressed in 1 bit, and in “XXX XXXX . . . ” subsequent thereto, a single “X” represents 1 bit, and the value of Z is expressed by this “XXX XXXX . . . ”.

In other words, FIG. 15 means that when the to-be-compressed numeric value “YY” continues for Z<128 pieces, the first byte expresses the to-be-compressed numeric value “YY”, the first bit of the next one byte is “0”, and the subsequent 7 bits express the value of “Z”. Further, FIG. 15 means that when the to-be-compressed numeric value “YY” continues for Z≧128 pieces, the first byte expresses the to-be-compressed numeric value “YY”, the expression covers the next 2 bytes (16 bits) by placing “1” at the first bit, and the subsequent 15 bits express the value of “Z”.

An example of the encoding illustrated in FIG. 14 will be described according to the rule illustrated in FIG. 15.

The head numeric value “06” of the data (upper line) of the higher-order sub-plane D1H inputted from the plane division section 25 in FIG. 7 is not the to-be-compressed numeric value and therefore, this “06” is directly outputted. Also, “02” of “02 02 02” subsequent to the head “06” is not the to-be-compressed numeric value and thus, these three of “02” also are directly outputted. Subsequently, there are four consecutive pieces of the to-be-compressed numeric value “01” and therefore, these are encoded into “01 04”. The next “04” and “05” are not the to-be-compressed numeric values and thus, “04 05” is directly outputted.

Subsequently, there are 32767 consecutive pieces of “00” and thus, “00” is placed, 1 bit at the head of the next 1 byte is turned “1”, and the next 15 bits are used to express 32767+128, so that there is expressed the fact that there are 32767 consecutive pieces of “00” by using 3 bytes of “00 FF 7F”. In other words, the number of consecutive pieces 128 is expressed by “00 00” except the first bit “1”.

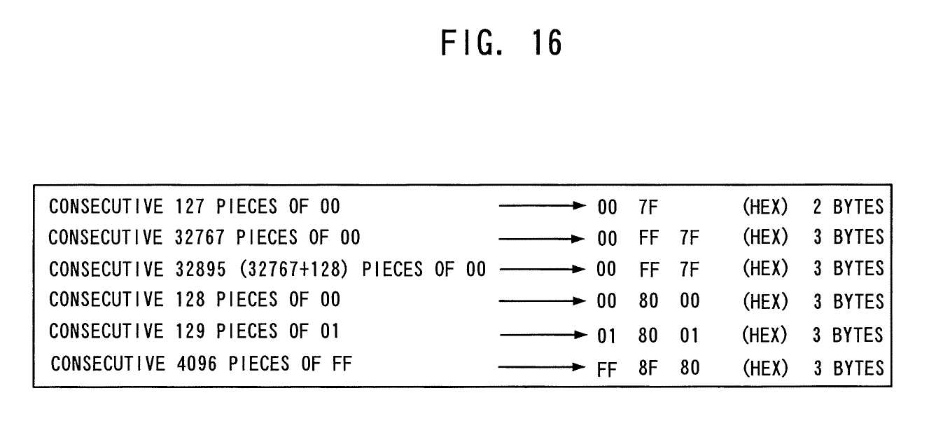

FIG. 16 is a diagram illustrating an example of the encoding processing according to the number of consecutive pieces in the run-length encoding section in FIG. 7.
When there are 127 consecutive pieces of “00”, these are encoded into “00 7F” using 2 bytes.
When there are 32767 consecutive pieces of “00”, these are encoded into “00 FF 7F” using 3 bytes.
When there are 32895 consecutive pieces of “00”, these are encoded into “00 FF FF” using 3 bytes.
When there are 128 consecutive pieces of “00”, these are encoded into “00 80 00” using 3 bytes.
When there are 129 consecutive pieces of “01”, these are encoded into “01 80 01” using 3 bytes.
   When there are 4096 consecutive pieces of “FF”, these are encoded into “FF 8F 80” using 3 bytes.

In the run-length encoding section 271 illustrated in FIG. 7, the above-described encoding processing is performed.

According to the run-length encoding section 271 of the present embodiment, the maximum compression ratio improves up to 3/32895=1/10965. Also, as described with reference to the histogram in FIG. 13, in the data of the higher-order sub-plane D1H targeted for the encoding processing by this run-length encoding section 271, most of 8-bit numeric values become numeric value “0” that corresponds to less than the original data value “256”. For this reason, significant data compression can be expected by the encoding processing in the run-length encoding section 271.

The data after being subjected to the encoding processing by the run-length encoding section 271 in FIG. 7 is subsequently inputted into the data scanning section 272 of the H-plane compression section 27 and the Huffman encoding section 273 in FIG. 7.

In this data scanning section 272, firstly, the whole data outputted from the run-length encoding section 271 is scanned, and the frequencies of occurrence of the data values are determined.

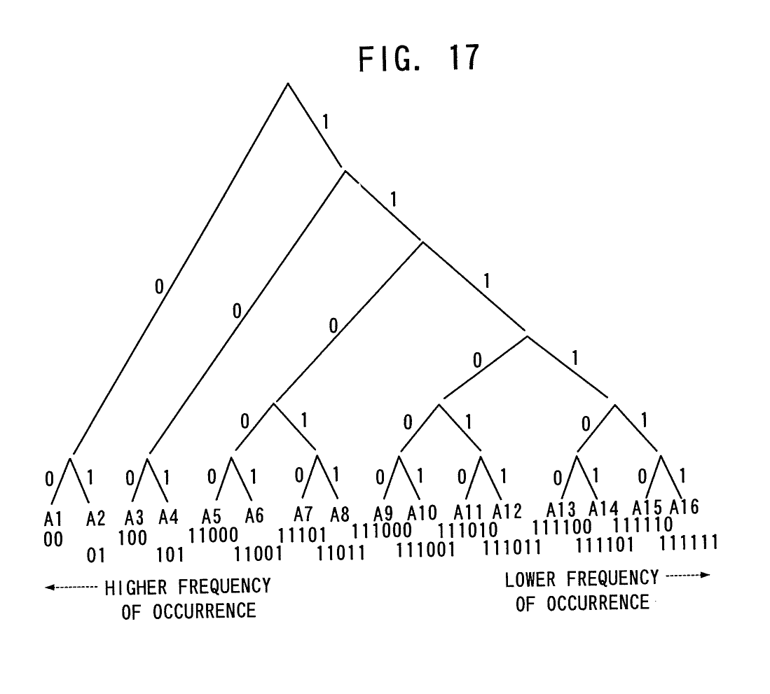

FIG. 17 is a diagram illustrating an example of the result obtained by scanning of the data scanning section.

Here, the frequency of occurrence of “A1” is the highest, followed by “A2”, “A3”, “A4”, and so on. Incidentally, these “A1”, “A2” and the like do not directly represent numeric values and are codes to express the numeric values. In other words, for example, “A1” expresses a numeric value “00”, and “A2” expresses a numeric value “FF”. Also, here, for the sake of simplicity, all the data values of the data sent from the run-length encoding section 271 in FIG. 7 are assumed to be any of 16 numeric values from “A1” to “A16”. Further, in the data scanning section 272, a code according to the frequency of occurrence is assigned to each of these 16 numeric values, and a Huffman table is created. In other words, a code “00” expressed in 2-bit is assigned to “A1” of the highest frequency of occurrence, and a code “01” expressed also in 2-bit is assigned to the next “A2”. Further, a code “100” and a code “101” each expressed in 3-bit are assigned to the next “A3” and further next “A4”, respectively, and each code expressed in 5-bit is assigned to each of the next “A5” to “A8”. Thereafter, similarly, a code expressed in the larger number of bit is assigned to the numeric value whose frequency of occurrence is lower.

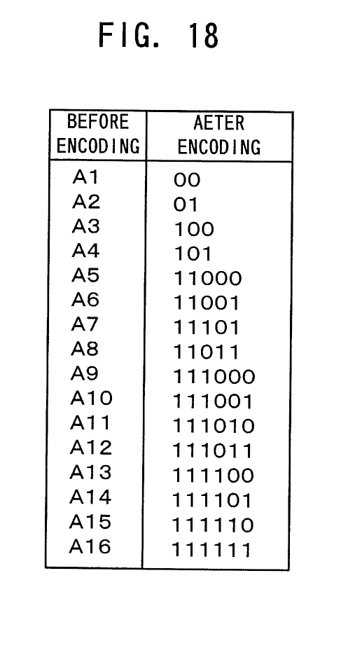

FIG. 18 is a diagram illustrating one example of the Huffman table.

This Huffman table is made to agree with FIG. 17. This is a correspondence table in which the numeric values are aligned so that the numeric values with higher frequencies of occurrence are replaced with the codes expressed in the smaller number of bits, and which shows correspondence between the numeric values before the encoding (before being replaced) and the numeric values after the encoding (after being replaced).

In the Huffman encoding section 273 of the H-plane compression section 27 in FIG. 7, the numeric values of data are encoded in accordance with the above-described Huffman table, and as a result, most of the numeric values are replaced with the codes in small numbers of bit, thereby realizing data compression.

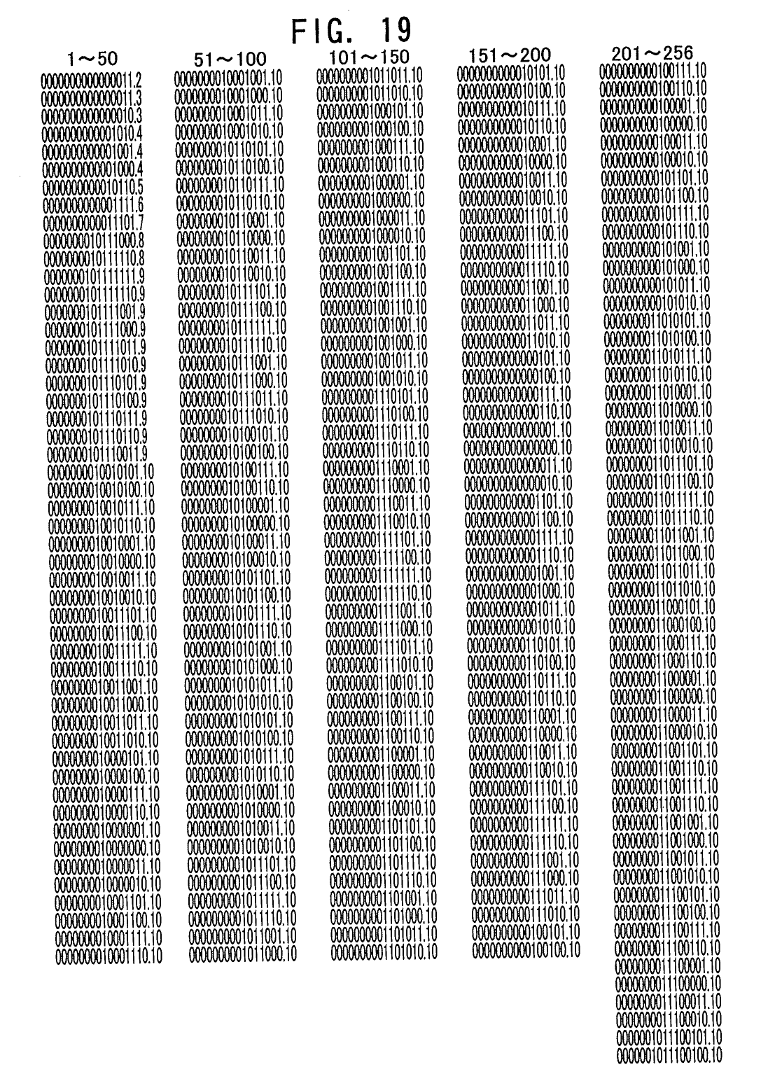

FIG. 19 is a diagram illustrating specific examples of the code string prepared in the Huffman table.

In each of the code strings illustrated in FIG. 19, a numeric value on the right side of “,” represents a bit length, and a binary code in the bit length aligned on the left side of the “,” represents an actual code. For example, the first code at the upper left in FIG. 17 is “11” in 2 bits, subsequently the second code is “011” in 3 bits, the third code is “010” in 3 bits, and the fourth code is “1010” in 4 bits. By using such a code string, the numeric values having higher frequencies of occurrence are replaced by the codes expressed in the smaller number of bits.

In the Huffman encoding section 273 of the H-plane compression section 27 in FIG. 7, the numeric values of data are encoded in accordance with the above-described Huffman table, and as a result, most of the numeric values are replaced with the codes in small numbers of bit, thereby realizing data compression.

The data encoded by the run-length encoding section 271 is converted into a code every 8 bits by the Huffman encoding section 273. By this conversion, the higher-order compressed data D2H that is variably encoded is generated.

By the above-described processing with reference to FIG. 14 through FIG. 19, the higher-order sub-plane D1H inputted into the H-plane compression section 27 in FIG. 7 is subjected to the encoding by the run-length encoding section 271 and the encoding by the Huffman encoding section 273, thereby being compressed at a high compression ratio and resulting in the higher-order compressed data D2H.

Next, the processing for the lower-order sub-plane D1L will be described. The lower-order sub-plane D1L obtained as a result of the division by the plane division section 25 is treated as consecutive 8-bit numeric values and subjected to the Huffman encoding processing described with reference to FIG. 17 through FIG. 19 in the Huffman encoding section 261. The Huffman table used for converting into a code in the Huffman encoding section 261 is generated by scanning of the data scanning section 263. The data inputted to the L-plane compression section is converted, every 8 bits, into a code by the Huffman encoding section 261. By this conversion, the lower-order compressed data D2L that is variably encoded is generated.

Incidentally, as described above, when the high-speed mode is instructed by the user, the mode switching section 262 is switched to and the lower-order sub-plane D1L is outputted from the L-plane compression section 26 as the lower-order compressed data D2L while omitting the Huffman encoding processing by the Huffman encoding section 261.

The higher-order compressed data D2H and the lower-order compressed data D2L are combined to generate one frame by the frame integration section 28, and the frame is transmitted by the communication I/F 36. In the frame, various types of settings necessary for decompression processing of the frame are inserted as a header. This header also includes a table used for the Huffman encoding.

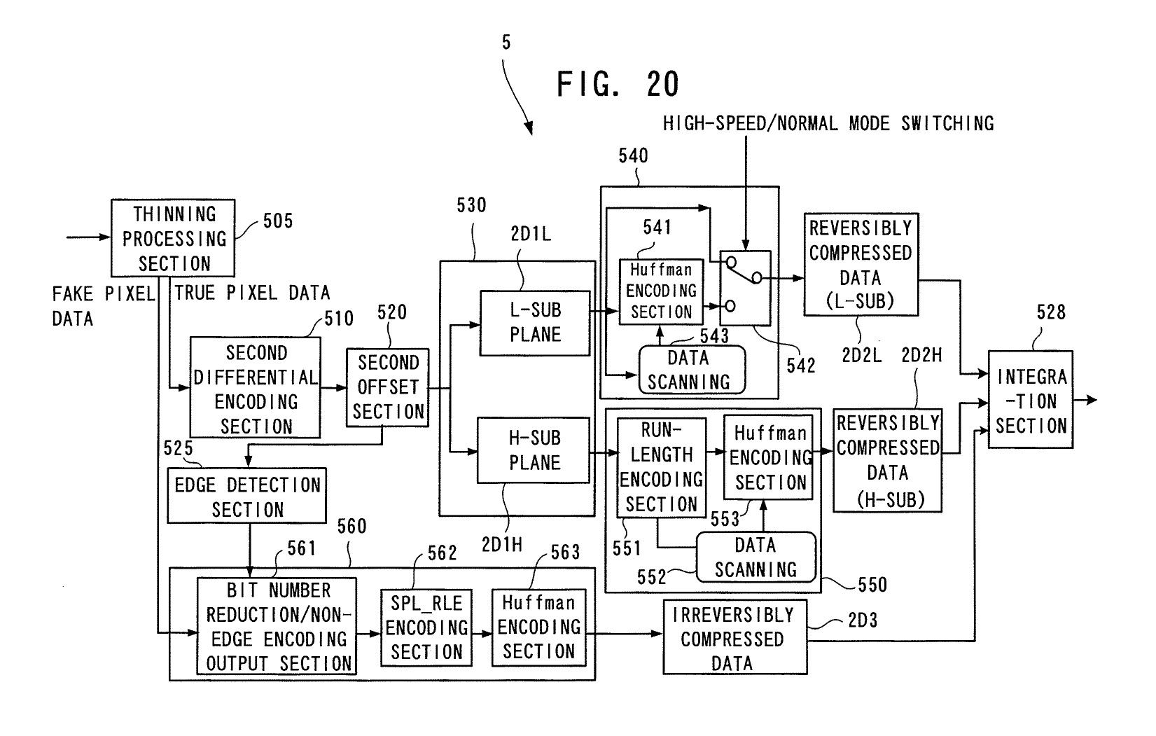

FIG. 20 is a diagram illustrating the irreversible compression section illustrated in FIG. 7.

The irreversible compression section 5 illustrated in FIG. 20 is a section to compress image data by using an irreversible compression algorithm, and data compression is performed at a high compression ratio.

The irreversible compression section 5 includes a thinning-out processing section 505 to thin out TRUE pixels that are subjected to the reversible compression processing from all pixels making up an image represented by image data, a FAKE-pixel-data compression section 560 and an edge detection section 525 as each section to apply the irreversible compression processing for FAKE pixels that remain after the thinning-out of the TRUE pixels and are subjected to the irreversible compression processing. Furthermore, in the irreversible compression section 5, as each section to apply the reversible compression processing for TRUE pixels, a second differential encoding section 510, a second offset section 520, a second plane division section 530, a second L-plane compression section 540 and a second H-plane compression section 550 are provided. Moreover, in the irreversible compression section 5, a frame integration section 528 is also provided. The thinning-out processing section 505, the second differential encoding section 510, the second offset section 520, the edge detection section 525, the FAKE-pixel-data compression section 560, the second plane division section 530, the second L-plane compression section 540, the second H-plane compression section 550, and the frame integration section 528 correspond to the thinning-out processing section S505, the second differential encoding processing section S510, the second offset processing section S520, the edge detection processing section S525, the FAKE image compression processing section S560, the second plane division processing section S530, the second L-plane compression processing section S540, the second H-plane compression processing section S550, and the integration processing section S528 of the image data compression program S illustrated in FIG. 3, respectively. Here, the thinning-out processing section 505 corresponds to one example of the thinning-out processing section according to the present invention.

The compression processing in the irreversible compression section 5 illustrated in FIG. 20 will be described.

When image data is inputted into the irreversible compression section 5, by the thinning-out processing section 505, the image data is divided into pixel data of TRUE pixels subjected to the reversible compression processing and pixel data of FAKE pixels subjected to the irreversible compression processing.

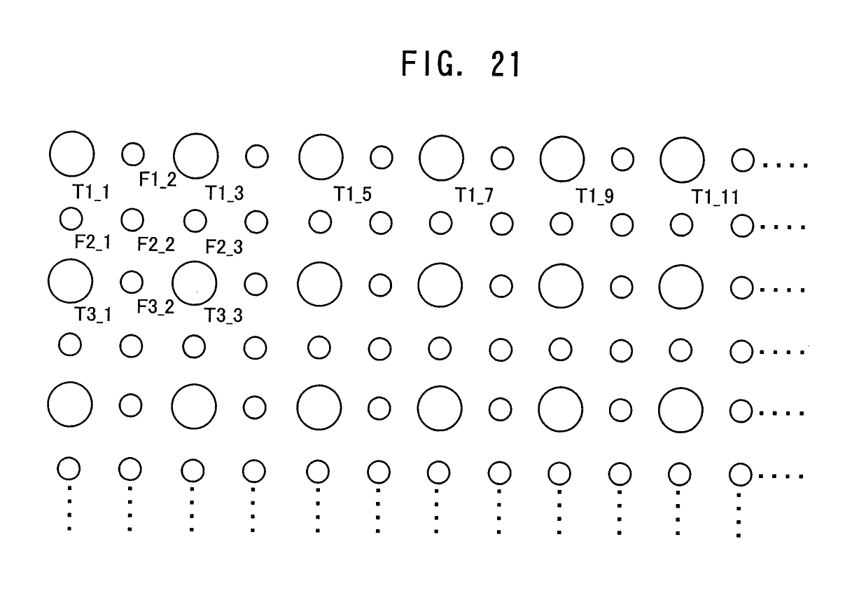

FIG. 21 is a diagram illustrating a concept of the thinning-out processing performed in the thinning-out processing section in FIG. 20.

FIG. 21 also illustrates a data structure of the image data.

In FIG. 21, the lateral direction of FIG. 21 is the main scanning direction, and the direction orthogonal to the main scanning direction is the sub-scanning direction. As described earlier, a row in which pixels are aligned along the main scanning direction is referred as the line, and pixels for the six lines are illustrated here. In FIG. 21, the position of each pixel is expressed by a subscript added to codes T and F each representing a pixel value. For example, in the third line, subscripts of 3_1, 3_2, 3_3, 3_4, . . . are sequentially added to the respective pixel values aligned in the main scanning direction.

The image data made up of the pixel values aligned in this manner is inputted into the thinning-out processing section 505 illustrated in FIG. 20, and the thinning-out processing section 505 classifies the respective pixels into the TRUE pixels and the FAKE pixels. The TRUE pixels among the pixels illustrated in FIG. 21 are each denoted by the code T, whereas the FAKE pixels among the pixels are each denoted by the code F. The TRUE pixels are periodically thinned out from the alignment of the pixels, and this diagram illustrates that in every other line (odd-numbered line) along the sub-scanning direction, every other TRUE pixel (odd-numbered pixel) along the main scanning direction is thinned out as the TRUE pixel. As a result, the TRUE pixels are equivalent to pixels of an image whose resolution is down to a half of the original resolution, and the pixels corresponding to a quarter of the pixels of the original image data are thinned out. The TRUE pixels thinned out in this manner form TRUE pixel data made up of consecutive TRUE pixels, and the TRUE pixel data has such a configuration that the pixels are aligned in the main scanning direction and the sub-scanning direction, similar to the original image data. Also, the FAKE pixels left by thinning out the TRUE pixels form FAKE pixel data made up of a series of the FAKE pixels. This FAKE pixel data is targeted for the irreversible compression processing, while the TRUE pixel data is targeted for the reversible compression processing.

The pixel data of the TRUE pixels is subjected to processing that is similar to the reversible compression processing in the reversible compression processing section C described with reference to FIG. 7, by the second differential encoding section 510, the second offset section 520, the second plane division section 530, the second L-plane compression section 540 and the second H-plane compression section 550 in the irreversible compression section 5. That is, in the second differential encoding section 510, second differential encoding processing similar to the one performed by the differential encoding section 510 is performed, the image data is inputted into the offset section 520 and offset by a predetermined amount. Then, in the second plane division section 530, the image data is divided into a lower-order sub-plane 2D1L made up of consecutive numeric values in lower-order bit and a higher-order sub-plane 2D1H made up of consecutive numeric values in higher-order bit, which are inputted into the second L-plane compression section 540 and the second H-plane compression section 550, respectively. The second L-plane compression section 540 and the second H-plane compression section 550 have configurations similar to those of the L-plane compression section 26 and the H-plane compression section 27 illustrated in FIG. 7, respectively. For example, the second L-plane compression section 540 is also provided with a Huffman encoding section 541, a mode switching section 542 and a data scanning section 543. By these sections, processing similar to the one applied by the L-plane compression section 26 illustrated in FIG. 7 is applied and a lower-order compressed data 2D2L is outputted. On the other hand, the second H-plane compression section 550 is provided with a run-length encoding section 551, a data scanning section 552 and a Huffman encoding section 553, and by these sections, processing similar to the one applied by the H-plane compression section 27 in FIG. 7 is applied and a higher-order compressed data 2D2H is outputted.

In contrast, the image data of the FAKE pixels is subjected to the irreversible compression processing by the FAKE-pixel-data compression section 560. This FAKE-pixel-data compression section 560 includes a bit number reduction/non-edge encoding output section 561, a run-length encoding section 562 and a Huffman encoding section 563. Numeric values included in the FAKE pixel data are replaced with, by the bit number reduction/non-edge encoding output section 561, either non-edge codes or numeric values expressed in the number of bits equal to or smaller than the number of unit bit of the original data. Here, in the bit number reduction/non-edge encoding output section 561, whether the numeric values included in the FAKE pixel data outputs a non-edge code or a numeric value expressed in smaller number of bits that is equal to or less than the number of bit unit of the original data is determined based on whether the FAKE pixel having the pixel value of the numeric value in interest is a pixel belonging to an edge portion of the image or not. The determination as to whether or not the FAKE pixel belongs to the edge portion is made by the edge detection section 525. In the following, explanation will be made by a concrete example in which the numeric value expressed in smaller bits is defined as 4-bit data and the non-edge code is defined as 1-bit data.

Based on the determination by the edge detection section 525, in the bit number reduction/non-edge encoding output section 561, a pixel value of the pixel belonging to the edge portion of the image is replaced with a 4-bit code, and a pixel value of the pixel not belonging to the edge portion is replaced with a 1-bit code. The data replaced with a 1-bit code or a 4-bit code is subjected to the exactly same processing as that in the H-plane compression section 27 illustrated in FIG. 7, by the run-length encoding section 562 and the Huffman encoding section 563. Here, the FAKE-pixel-data compression section 560 also includes a data scanning section that functions similarly to the data scanning section 272 of the H-plane compression section 27 in FIG. 7, but its illustration is omitted. The FAKE pixel data after being subjected to the run-length encoding processing and the Huffman encoding processing is outputted from the FAKE-pixel-data compression section 560 as an irreversibly compressed data 2D3.

Next, the irreversible compression processing for the FAKE pixel data will be described. The FAKE pixel data obtained by the thinning-out processing section 505 is inputted into the FAKE-pixel-data compression section 560. The bit number reduction/non-edge encoding output section 561 in the FAKE-pixel-data compression section 560 outputs either a code indicating that the FAKE pixel data is not an edge portion or a numeric value expressed in the number of bits equal to or smaller than the number of unit bit of the original data, depending on whether or not the FAKE pixel data is of an edge portion. Whether the FAKE pixel data is of the edge portion or not is determined by the edge detection section 525 in FIG. 20, based on a differential data after the offset by the second offset section 520.

In the following, how the FAKE pixel data is encoded will be described.

When the pixel value of the TRUE pixel illustrated in FIG. 21 is expressed by Tn_k, the pixel value of the FAKE pixel adjacent to this TRUE pixel is expressed by Fn_k+1, Fn+1_k, Fn+1_k+1, . . . . The pixel value of another TRUE pixel at a position over the FAKE pixel adjacent to the TRUE pixel is expressed by Tn_k+2, Tn+2_k, Tn+2_k+2, . . . . In the edge detection section 2525, when a differential value obtained by the two-dimensional differential encoding processing from these four TRUE pixels' pixel values Tn_k, Tn_k+2, Tn+2_k and Tn+2_k+2 (here, not a difference value expressed by the numeric value from “00” to “FF” in hexadecimal notation as described above, but a difference value obtained by directly acquiring a difference of the pixel values and expressed in decimal notation) belongs to a domain bellow (−L) or a domain equal to or above (+L) defined by using a positive integer-value threshold parameter L set in the edge detection section 2525, the above-mentioned three FAKE pixels' pixel values Fn_k+1, Fn+1_k and Fn+1_k+1 are determined to be the pixel values at an edge portion and each encoded into a 4-bit code starting from “1” by the bit number reduction/non-edge encoding output section 2561.

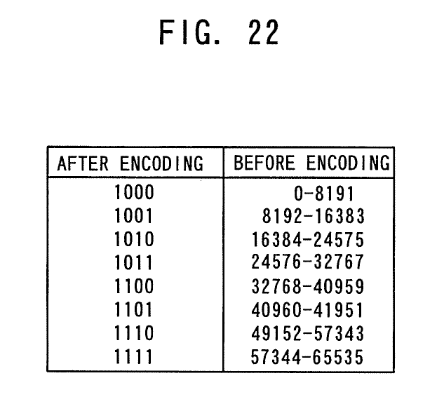

FIG. 22 is a diagram illustrating an encoding scheme into 4-bit code.

In this encoding scheme, if the number of unit bit of the original data representing the pixel value is 16, the pixel value of the FAKE pixel is encoded into a code of “1000”-“1111” by cutting off lower-order 13 digits of the 16-bit value and adding “1” to the head of the remaining higher-order 3 digits. Thus, as illustrated in the list of this diagram, among the numeric values “0”-“65535” before the encoding, the numeric values “0”-“8191” are encoded into “1000”, and the numeric values “8192”-“16383” are encoded into “1001”. Similarly, the numeric values “16384”-“24575”, “24576”-“32767”, “32768”-“40959”, “40960”-“41951”, “41952”-“57343” and “57344”-“65535” are encoded into “1010”, “1011”, “1100”, “1101”, “1110” and “1111”, respectively. Such encoding mode is obtained by a significantly simple processing of cutting off digits of a bit value. By such encoding into the 4-bit code, the information of the original image is maintained to some extent, avoiding deterioration of the image quality.

In the edge detection section 525, when the difference value obtained from the above-mentioned four TRUE pixels' pixel values Tn_k, Tn_k+2, Tn+2_k and Tn₊2_k+2 by the two-dimensional differential encoding processing belongs to a domain of not less than (−L) and not more than (+L), the above-mentioned three FAKE pixels' pixel values Fn_k+1, Fn+1_k and Fn+1_k+1 are determined not to be the pixel values at an edge portion and encoded into a 1-bit code “0” in the bit number reduction/non-edge encoding output section 561.

The data replaced with the 1-bit or 4-bit code is subjected, by the run-length encoding section 562 and the Huffman encoding section 563, to the processing that is exactly same as the above-described processing in the H-plane compression section 27 illustrated in FIG. 7. Here, the FAKE-pixel-data compression section 560 also includes a data scanning section that functions like the data scanning section 272 of the H-plane compression section 27 illustrated in FIG. 7, but its illustration is omitted in FIG. 20. The FAKE pixel data after being subjected to the run-length encoding processing and the Huffman encoding processing is outputted from the FAKE-pixel-data compression section 560 as the irreversibly compressed data 2D3.

A group made up of the lower-order compressed data 2D2L and the higher-order compressed data 2D2H outputted by the second L-plane compression section 540 and the second H-plane compression section 550, respectively, and the irreversibly compressed data 2D3 that is further added forms the compressed data obtained by subjecting the original image data to the irreversible compression processing in the irreversible compression section 5. This compressed data is inputted into the frame integration section 528.

The frame integration section 528 combines the lower-order compressed data 2D2L, the higher-order compressed data 2D2H and the irreversibly compressed data 2D3 to generate a frame.

In the above-described processing by the irreversible compression section 5, information is lost and even with the decompression processing, the information is not completely restored. However, the information is maintained to the extent of allowing determination in a natural image. Further, the compression processing in the irreversible compression section 5 achieves a remarkably high compression ratio compared to the reversible compression section 2.

In the compression processing section C according to the present embodiment, the above-described reversible compression processing and irreversible compression processing are appropriately selected based on a difference between a maximum value and a minimum value of pixel values, thereby improving a compression ration of data while suppressing degradation of image quality of a character and a line drawing.

Incidentally, in the above-described embodiment, as an example of the block in the compression control section according to the present invention, the compression control section 6 that divides the screen P of received data into blocks in M lines×N columns. However, the present invention is not limited to this and, for example, the plural blocks may have different sizes from one another.

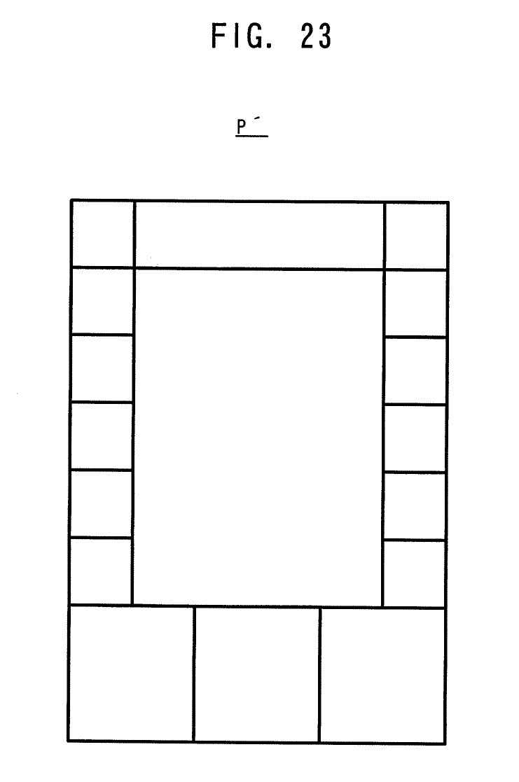

FIG. 23 is a diagram illustrating an example of a data screen divided into blocks differently from those in FIG. 5. The compression control section according to the present invention may divide a screen P2, for example, into blocks having different sizes from one another as illustrated in FIG. 23, based on a result of a simple image analysis as preprocessing or a standard arrangement of components in an image. Furthermore, a block of the compression control section according to the present invention may have, for example, one having a belt shape that extends in a lateral direction that vertically divides one screen.

In the above-described embodiments, as an example of the encoding section according to the present invention, the encoding section that Huffman encodes the data after being subjected to the encode processing is described. However, the invention is not limited to this and may Huffman encode the data after being subjected to discrete cosine transformation.

Additionally, in the above-described embodiments, the radiography detection unit 3 of the radiographic image diagnosis system S is described as an example of the image data compression apparatus according to the invention. However, the invention is not limited to this and, for example, the image data compression apparatus may be a digital camera.

Also, in the above-described embodiments, the radiography detection unit 3 that includes the compression processing section C that is constructed by the image data compression program is described as an example of the image data compression apparatus. However, the invention is not limited to this and, for example, the image data compression program may be formed by a logic circuit.

What is claimed is:

1. An image data compression apparatus, comprising:
a reversible compression section that applies reversible compression processing to to-be-compressed data made of a series of numeric values;
an irreversible compression section that applies irreversible compression processing to to-be-compressed data made of a series of numeric values; and
a compression control section that causes, if a difference between a maximum value and a minimum value in a plurality of pixel values representing a plurality of pixels forming an image is within a range from a predetermined upper limit to a predetermined lower limit, the irreversible compression section to execute the irreversible compression processing for the plurality of pixel values as the to-be-compressed data, and that causes, if the difference is out of the range, the reversible compression section to execute the reversible compression processing for the plurality of pixel values as the to-be-compressed data.

2. The image data compression apparatus according to claim 1, wherein the compression control section causes, for each of a plurality of blocks into which one screen is divided, of the reversible compression processing and the irreversible compression processing, compression processing according to the difference between the maximum value and the minimum value in each block to be executed.

3. The image data compression apparatus according to claim 1, wherein the reversible compression section comprises:
a differential generating section that determines a difference between numeric values adjacent to each other directly or with a certain space therebetween, for a series of numeric values forming the to-be-compressed data, so as to generate new to-be-compressed data made of a series of numeric values expressed in a unit number each representing the difference;
an offset section that offsets by a predetermined value each numeric value included in the new to-be-compressed data generated by the differential generating section;
a division section that divides each of numeric values of the to-be-compressed data which are offset by the offset section into a higher-order bit portion and a lower-order bit portion, at a predetermined division bit number smaller than the unit bit number, so as to divide the to-be-compressed data into higher-order data made of a series of higher-order bit portions of the respective numeric values and lower-order data made of a series of higher-order bit portions of the respective numeric values;
a consecutive encoding section that directly outputs, with respect to numeric values except one or a plurality of predetermined compression-targeted numeric values in the higher-order data, and that encodes, with respect to compression target numeric values, the compression target numeric values to the compression target numeric value and a numeric value representing the number of consecutive pieces of a compression target numeric value that is identical to the compression target numeric value, so as to be outputted; and
an entropy encoding section that subjects data after being encoded in the consecutive encoding section to entropy encoding by using a table which associates a corresponding code with a numeric value.

4. The image data compression apparatus according to claim 1, wherein the irreversible compression section comprises:
a thinning-out processing section that periodically thins out a numeric value from a series of numeric values included in the to-be-compressed data, so as to generate first to-be-compressed data made of a series of numeric values taken out of the to-be-compressed data by the thinning-out and second to-be-compressed data made of a series of remaining numeric values; and
a bit number restriction section that outputs, with respect to numeric values included in the second to-be-compressed data generated by the thinning-out processing section, a numeric value re-expressed in a bit number smaller than a unit bit number.

5. A computer-readable storage medium that stores an image data compression program to perform data compression processing, which is executed in an information processing apparatus, thereby constructing on the information processing apparatus:
a reversible compression section that applies reversible compression processing to to-be-compressed data made of a series of numeric values;
an irreversible compression section that applies irreversible compression processing to to-be-compressed data made of a series of numeric values; and
a compression control section that causes, if a difference between a maximum value and a minimum value in a plurality of pixel values representing a plurality of pixels forming an image is within a range from a predetermined upper limit to a predetermined lower limit, the irreversible compression section to execute the irreversible compression processing for the plurality of pixel values as the to-be-compressed data, and that causes, if the difference is out of the range, the reversible compression section to execute the reversible compression processing for the plurality of pixel values as the to-be-compressed data.
